(19) United States
(12) Patent Application Publication
(10) Pub. No.: US 2017/0185856 A1
(43) Pub. Date: Jun. 29, 2017

(54) METHOD, STORAGE MEDIUM, AND ELECTRONIC DEVICE FOR EXECUTING FUNCTION BASED ON BIOMETRIC SIGNAL

(71) Applicant: Samsung Electronics Co., Ltd., Gyeonggi-do (KR)

(72) Inventors: Jae-Hyun PARK, Seoul (KR); Jung-Hoon PARK, Seoul (KR); Jun-Ho KOH, Gyeonggi-do (KR); Yong-Chan LEE, Seoul (KR); Jae-Ho JUNG, Gyeonggi-do (KR)

(73) Assignee: Samsung Electronics Co., Ltd.

(21) Appl. No.: 15/388,467

(22) Filed: Dec. 22, 2016

(30) Foreign Application Priority Data
Dec. 24, 2015 (KR) 10-2015-0186816

(51) Int. Cl. G06K 9/00

(52) U.S. Cl. CPC G06K 9/00892; G06K 9/00442

(57) ABSTRACT

A method, storage medium, and electronic device for executing a function based on a biometric signal are provided. The electronic device includes a memory, and a processor that acquires a first biometric signal, detect, from the first biometric signal, a part of a first signal pattern including at least one of at least one signal of a first type and at least one signal of a second type, and executes a first function corresponding to the first signal pattern.

### PRIORITY

This application claims priority under 35 U.S.C. §119(a) to a Korean Patent Application filed in the Korean Intellectual Property Office on Dec. 24, 2015, and assigned Serial No. 10-2015-0186816, the entire disclosure of which is incorporated herein by reference.

### BACKGROUND

1. Field of the Disclosure

The present disclosure relates generally to a method for executing a function in an electronic device, and an electronic device therefor.

2. Description of the Related Art

An electronic device is capable of executing a variety of functions in multiple ways. For example, portable terminals such as smartphones are under development to provide increased convenience to users, while achieving improved performance.

Among the functions of the electronic device, some functions are executed using sensors. The sensors collect information about the electronic device, information about the surroundings of the electronic device, or information about a user.

The electronic device may include one or more sensors and provide multiple services using information collected through the sensors.

### SUMMARY

The present disclosure has been made to address at least the above-mentioned problems and/or disadvantages and to provide at least the advantages described below.

Accordingly, an aspect of the present disclosure is to provide a method for readily controlling an electronic device in a situation where the electronic device may not be controlled directly, a user has difficulty in moving, or the electronic device should be controlled without intervention of other persons, such as during a conference, while driving, etc.

In accordance with an aspect of the present disclosure, an electronic device is provided. The electronic device includes a memory, and a processor that acquires a first biometric signal, detects, from the first biometric signal, a part of a first signal pattern including at least one of at least one signal of a first type and at least one signal of a second type, and executes a first function corresponding to the first signal pattern.

In accordance with another aspect of the present disclosure, a method for executing a function based on a biometric signal in an electronic device is provided. The method includes acquiring a first biometric signal, detecting, from the first biometric signal, a part of a first signal pattern including at least one of at least one signal of a first type and at least one signal of a second type, and executing a first function corresponding to the first signal pattern.

In accordance with another aspect of the present disclosure, a non-transitory storage medium having stored thereon commands is provided for executing the steps for acquiring a first biometric signal, detecting, from the first biometric signal, a part of a first signal pattern including at least one of at least one signal of a first type and at least one signal of a second type, and executing a first function corresponding to the first signal pattern.

### BRIEF DESCRIPTION OF THE DRAWINGS

The above and other aspects, features and advantages of certain exemplary embodiments of the present disclosure will be more apparent from the following description taken in conjunction with the accompanying drawings, in which:

FIG. 1 is a block diagram of a configuration of an electronic device in a network environment, according to an embodiment of the present disclosure;

FIG. 2 is a block diagram of a configuration of an electronic device, according to an embodiment of the present disclosure;

FIG. 3 is a block diagram of a communication system, according to an embodiment of the present disclosure;

FIGS. 4A and 4B illustrate a second electronic device, according to an embodiment of the present disclosure;

FIG. 5 illustrates a second electronic device, according to an embodiment of the present disclosure;

FIG. 6 illustrates a second electronic device, according to an embodiment of the present disclosure;

FIGS. 7A, 7B, and 7C illustrate a second electronic device, according to an embodiment of the present disclosure;

FIG. 8 illustrates a second electronic device, according to an embodiment of the present disclosure;

FIG. 9 illustrates a second electronic device, according to an embodiment of the present disclosure;

FIG. 10 is a flowchart of a method for executing a function based on a biometric signal, according to an embodiment of the present disclosure;

FIG. 11 is a flowchart of a method for detecting a signal pattern, according to an embodiment of the present disclosure;

FIGS. 12A, 12B, 12C, and 12D illustrate a method for detecting a signal pattern, according to an embodiment of the present disclosure;

FIG. 13 is a flowchart of a method for executing a function based on a biometric signal, according to an embodiment of the present disclosure;

FIG. 14 is a flowchart of a method for executing a function based on a biometric signal, according to an embodiment of the present disclosure;

FIG. 15 is a signal flow diagram of a method for executing a function based on a biometric signal, according to an embodiment of the present disclosure;

FIGS. 16A, 16B, and 16C illustrate a method for executing a function based on a biometric signal, according to an embodiment of the present disclosure;

FIG. 17 is a signal flow diagram of a method for executing a function based on a biometric signal, according to an embodiment of the present disclosure; and

FIGS. 18A, 18B, and 18C illustrate a method for executing a function based on a biometric signal, according to an embodiment of the present disclosure.

### DETAILED DESCRIPTION OF EMBODIMENTS OF THE PRESENT DISCLOSURE

Various embodiments of the present disclosure are described with reference to the accompanying drawings. However, the scope of the present disclosure is not intended to be limited to the particular embodiments described herein, and it is to be understood that the present disclosure covers all modifications, equivalents, and/or alternatives falling within the scope and spirit of the present disclosure. In relation to a description of the drawings, like reference numerals denote the same components.

In the present disclosure, the terms ‘have’, ‘may have’, ‘include’, and ‘may include’ signify the presence of a specific feature (for example, number, function, operation, or component such as part), and are not intended to exclude the presence of one or more other features.

In present disclosure, the terms ‘A or B’, ‘at least one of A or/and B’, ‘A/B’, and ‘one or more of A or/and B’ may cover all possible combinations of enumerated items. For example, ‘A or B’, ‘at least one of A and B’, and ‘at least one of A or B’ may represent all of the cases of (1) inclusion of A, (2) inclusion of B, and (3) inclusion of A and B.

The terms ‘first’, ‘second’, etc., as used herein, may modify the names of various components irrespective of sequence and/or importance, and are not intended to limit the components. These expressions are used to distinguish one component from another component. For example, a first user equipment (UE) and a second UE may indicate different UEs irrespective of sequence or importance. For example, a first component may be referred to as a second component and vice versa without departing the scope of the present disclosure.

When it is said that a component (for example, a first component) is operatively or communicatively ‘coupled’ or ‘connected’ with/to another component (for example, a second component), it should be understood that the first component is connected to the second component directly or through another component (for example, a third component). On the other hand, when it is said that a component (for example, a first component) is ‘directly connected’ or ‘directly coupled’ with/to another component (for example, a second component), it may be understood that there is no other component (for example, a third component) between the first and second components.

The term ‘configured to’, as used herein, may be used interchangeably with the terms ‘suitable for’ ‘having the capacity to’, ‘designed to’, ‘adapted to’, ‘made to’, or ‘capable of’ under certain circumstances. The term ‘configured to’ may not necessarily mean ‘specifically designed to’ in hardware. Instead, the term ‘configured to’ may mean that a device is ‘capable of’ with another device or part. For example, ‘a processor configured to execute A, B, and C’ may mean a dedicated processor (for example, an embedded processor) for performing the corresponding operations or a generic-purpose processor (for example, a central processing unit (CPU) or an application processor (AP)) for performing the corresponding operations.

The terms as used in the present disclosure are provided merely to describe specific embodiments, and are not intended to limit the scope of other embodiments. It is to be understood that singular forms include plural referents, unless the context clearly dictates otherwise. Unless otherwise defined, the terms and words, including technical or scientific terms, used in the following description and claims may have the same meanings as generally understood by those skilled in the art to which the present disclosure pertains. The terms as generally defined in dictionaries may be interpreted as having the same or similar meanings as or to contextual meanings in the related technology. Unless otherwise defined, the terms should not be interpreted in an idealized or excessively formal manner When needed, even the terms as defined in the present disclosure may not be interpreted as excluding embodiments of the present disclosure.

An electronic device, according to an embodiment of the present disclosure, may be at least one of a smailphone, a tablet Personal Computer (PC), a mobile phone, a video phone, an e-Book reader, a desktop PC, a laptop PC, a netbook computer, a workstation, a server, a personal digital assistant (PDA), a portable multimedia player (PMP), an MP3 player, a mobile medical equipment, a camera, or a wearable device. The wearable device may be at least one of an accessory type (for example, a watch, a ring, a bracelet, an ankle bracelet, glasses, contact lenses, or a head-mounted device (HMD)), a fabric or clothes type (for example, electronic clothes), a body-attached type (for example, a skin pad or a tattoo), or an implantable type (for example, an implantable circuit).

According to some embodiments of the present disclosure, an electronic device may be a home appliance. For example, the home appliance may be at least one of a television (TV), a digital versatile disk (DVD) player, an audio player, a refrigerator, an air conditioner, a vacuum cleaner, an oven, a microwave oven, a washer, an air purifier, a set-top box, a home automation control panel, a security control panel, a TV box (for example, Samsung HomeSync™, Apple TV™, Google TV™, etc.), a game console (for example, Xbox™, PlayStation™, etc.), an electronic dictionary, an electronic key, a camcorder, or an electronic picture frame.

According to other embodiments of the present disclosure, an electronic device may be at least one of a medical device (for example, a portable medical meter such as a blood glucose meter, a heart rate meter, a blood pressure meter, or a body temperature meter, a magnetic resonance angiography (MRA) device, a magnetic resonance imaging (MRI) device, a computed tomography (CT) device, an imaging device, an ultrasonic device, etc.), a navigation device, a global navigation satellite system (GNSS), an event data recorder (EDR), a flight data recorder (FDR), an automotive infotainment device, a naval electronic device (for example, a naval navigation device, a gyrocompass, or the like), an avionic electronic device, a security device, an in-vehicle head unit, an industrial or consumer robot, an automatic teller machine (ATM), a point of sales (POS) device, or an Internet of Things (IoT) device (for example, a light bulb, various sensors, an electricity or gas meter, a sprinkler, a fire alarm, a thermostat, a street lamp, a toaster, sporting goods, a hot water tank, a heater, or a boiler).

According to some embodiments of the present disclosure, an electronic device may be at least one of furniture, part of a building/structure, an electronic board, an electronic signature receiving device, a projector, and various measuring devices (for example, water, electricity, gas or electro-magnetic wave measuring devices).

According to various embodiments of the present disclosure, an electronic device may be one or a combination of two or more of the foregoing devices. The electronic device may be a flexible electronic device. In addition, it will be apparent to one having ordinary skill in the art that an electronic device of the present disclosure is not limited to the foregoing devices and covers a new electronic device produced along with technology development.

With reference to the attached drawings, an electronic device according to an embodiment will be described below. In the present disclosure, the term ‘user’ may refer to a person or device (for example, an artificial intelligence electronic device) that uses an electronic device.

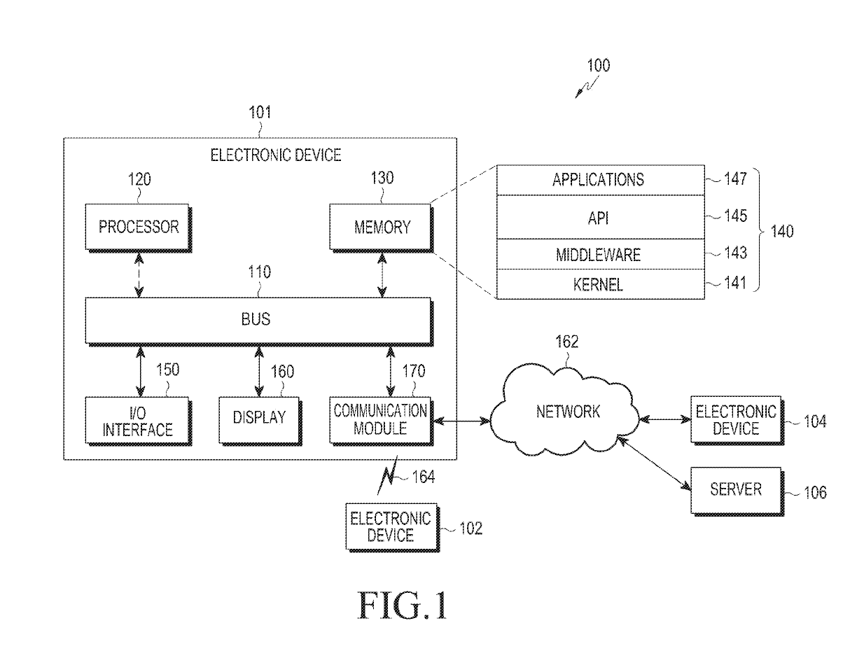

FIG. 1 is a block diagram of a configuration of an electronic device in a network environment, according to an embodiment of the present disclosure.

Referring to FIG. 1, an electronic device 101 in a network environment 100 is described. The electronic device 101 includes a bus 110, a processor 120, a memory 130, an input/output (I/O) interface 150, a display 160, and a communication module 170. In some embodiments, at least one of the components may be omitted in the electronic device 101 or a component may be added to the electronic device 101.

The bus 110 includes a circuit that interconnects the foregoing components 120, 130, 150, 160, and 170 and allows communication (for example, control messages and/or data) between the foregoing components of the electronic device 101.

The processor 120 includes one or more of a CPU, an AP, or a communication processor (CP). The processor 120 executes computation or data processing related to control and/or communication of at least one other component of the electronic device 101. The processor 120 may be referred to as a controller, the processor 120 may include the controller as its part, or the processor 120 may form the controller.

The memory 130 may include a volatile memory and/or a non-volatile memory. The memory 130 stores instructions or data related to at least one other component of the electronic device 101. The memory 130 stores software and/or programs 140.

The programs 140 include a kernel 141, middleware 143, an application programming interface (API) 145, and/or applications 147. At least a part of the kernel 141, the middleware 143, and the API 145 may be called an operating system (OS).

The kernel 141 controls or manages system resources (for example, the bus 110, the processor 120, or the memory 130) that are used in executing operations or functions implemented in other programs such as the middleware 143, the API 145, or the applications 147. Also, the kernel 141 may provide an interface for allowing the middleware 143, the API 145, or the applications 147 to access and control or manage individual components of the electronic device 101.

The middleware 143 serves as a medium through which the kernel 141 communicates with the API 145 or the applications 147 to transmit and receive data.

Also, the middleware 143 processes one or more task requests received from the applications 147 according to their priority levels. For example, the middleware 143 assigns priority levels for using system resources (the bus 110, the processor 120, or the memory 130) of the electronic device 101 to at least one of the applications 147. For example, the middleware 143 performs scheduling or load balancing for the one or more task requests according to the priority levels assigned to the at least one of the applications 147.

The API 145 is an interface that controls functions that the applications 147 provide at the kernel 141 or the middleware 143. For example, the API 145 may include at least one interface or function (for example, a command) for file control, window control, video processing, or text control.

The I/O interface 150 acts as an interface that provides a command or data received from a user or an external device to the other components of the electronic device 101. Further, the I/O interface 150 outputs a command or data received from the other components of the electronic device 101 to the user or the external device.

The display 160 may include a liquid crystal display (LCD), a light emitting diode (LED) display, an organic LED (OLED) display, a microelectromechanical systems (MEMS) display, or an electronic paper display. The display 160 displays various types of content (for example, text, an image, a video, an icon, or a symbol) to the user. The display 160 may include a touch screen and receive a touch input, a gesture input, a proximity input, or a hovering input through an electronic pen or a user's body part.

The communication module 170 establishes communication between the electronic device 101 and a first external electronic device 102, a second external electronic device 104, or a server 106. For example, the communication module 170 may be connected to a network 162 by wireless communication or wired communication and communicate with the second external electronic device 104 or the server 106 over the network 162. The communication module 170 may include a CP, and the CP may be one of a plurality of (i.e., two or more) modules in the communication module 170. The CP may be incorporated in the processor 120.

The wireless communication may be conducted using at least one of long term evolution (LTE), LTE-advanced (LTE-A), code division multiple access (CDMA), wideband CDMA (WCDMA), universal mobile telecommunication system (UMTS), wireless broadband (WiBro), or global system for mobile communications (GSM), as a cellular communication protocol. The wireless communication may include short-range communication 164. The short-range communication 164 may be conducted by at least one of WiFi, Bluetooth, near field communication (NFC), or GNSS. GNSS includes at least one of global positioning system (GPS), global navigation satellite system (Glonass), Beidou navigation satellite system, or Galileo, the European global satellite-based navigation system, according to a region using the GNSS or a bandwidth used. In the present disclosure, the terms ‘GPS’ and ‘GNSS’ are interchangeably used with each other.

The wired communication may be conducted in conformance to at least one of universal serial bus (USB), high definition multimedia interface (HDMI), recommended standard 232 (RS-232), or plain old telephone service (POTS). The network 162 is a telecommunication network, for example, a computer network (for example, local area network (LAN) or wide area network (WAN)), the Internet, or a telephone network.

Each of the first and second external electronic devices 102 and 104 may be of the same type as or a different type from the electronic device 101. The server 106 may include a group of one or more servers. All or a part of operations performed in the electronic device 101 may be performed in one or more other electronic devices, such as, the external electronic devices 102 and 104, or the server 106. If the electronic device 101 is to perform a function or a service automatically or upon request, the electronic device 101 may request the external electronic device 102 or 104, or the server 106 to perform at least a part of functions related to the function or the service, instead of performing the function or the service autonomously, or additionally. The external electronic device 102 or 104, or the server 106 may execute the requested function or an additional function and provide a result of the function execution to the electronic device 101. The electronic device 101 may provide the requested function or service based on the received result or by additionally processing the received result. For this purpose cloud computing, distributed computing, or client-server computing may be used.

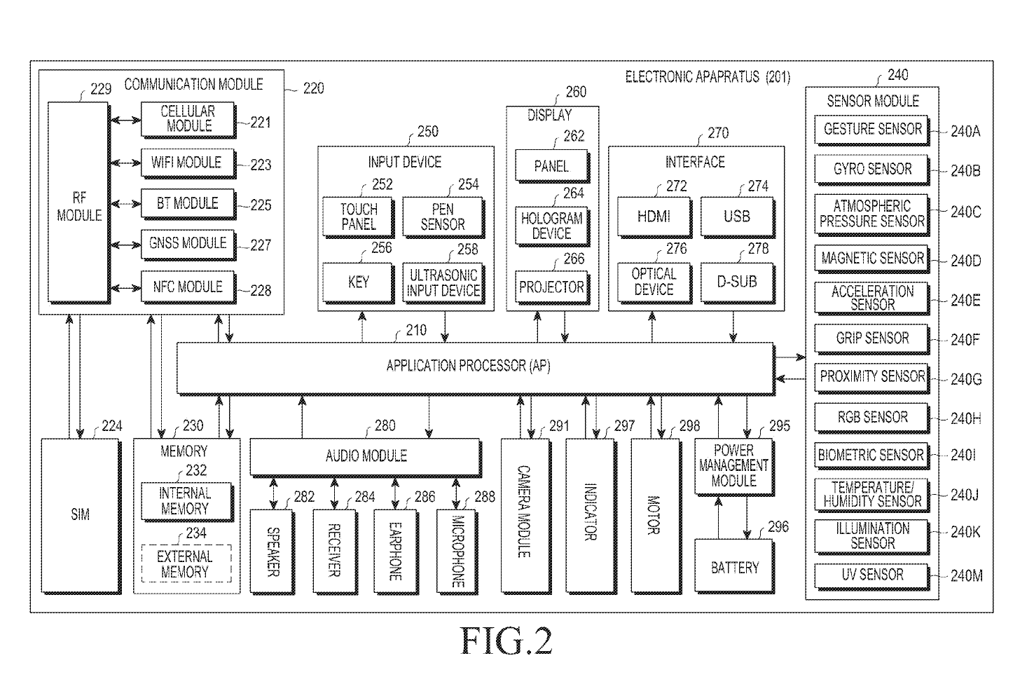

FIG. 2 is a block diagram of a configuration of an electronic device, according to an embodiment of the present disclosure.

Referring to FIG. 2, an electronic device 201 is provided. The electronic device 201 may include all or part of the electronic device 101 illustrated in FIG. 1. The electronic device 201 includes at least one application processor (AP) 210, a communication module 220, a memory 230, a sensor module 240, an input device 250, and a display 260. The electronic device 201 may further include at least one of a subscriber identification module (SIM) 224, an interface 270, an audio module 280, a camera module 291, a power management module 295, a battery 296, an indicator 297, and a motor 298.

The processor 210 controls a plurality of (i.e., two or more) hardware or software components that are connected to the processor 210 by executing an OS or an application program and performs processing or computation of various types of data. The processor 210 may be implemented as a system on chip (SoC). The processor 210 may further include a graphics processing unit (GPU) and/or an image signal processor. The processor 210 may include at least a part (for example, a cellular module 221) of the components illustrated in FIG. 2. The processor 210 loads a command or data received from at least one of other components (for example, a non-volatile memory), processes the loaded command or data, and stores various types of data in the non-volatile memory.

The communication module 220 may have the same configuration as or a similar configuration to the communication module 170 illustrated in FIG. 1. The communication module 220 may include the cellular module 221, a WiFi module 223, a BT module 225, a GNSS module 227 (for example, a GPS module, a Glonass module, a Beidou module, or a Galileo module), an NFC module 228, and a radio frequency (RF) module 229.

The cellular module 221 provides services such as voice call, video call, text service, or the Internet service through a communication network. The cellular module 221 identifies and authenticates the electronic device 201 within a communication network, using the SIM 224. The cellular module 221 may perform at least a part of the functionalities of the processor 210. The cellular module 221 may include a CP.

Each of the WiFi module 223, the BT module 225, the GNSS module 227, and the NFC module 228 may include a processor that processes data received or transmitted by the respective modules. At least a part of the cellular module 221, the WiFi module 223, the BT module 225, the GNSS module 227, or the NFC module 228 may be included in a single integrated chip (IC) or IC package.

The RF module 229 transmits and receives communication signals (for example, RF signals).

The RF module 229 may include a transceiver, a power amplifier module (PAM), a frequency filter, a low noise amplifier (LNA), an antenna, etc. At least one of the cellular module 221, the WiFi module 223, the BT module 225, the GNSS module 227, or the NFC module 228 may transmit and receive RF signals via a separate RF module.

The SIM 224 may include a card or an embedded SIM. The SIM 224 includes a unique identifier (for example, integrated circuit card identifier (ICCID)) or subscriber information (for example, international mobile subscriber identity (IMSI)).

The memory 230 (for example, the memory 130 of FIG. 1) may include an internal memory 232 or an external memory 234.

The internal memory 232 may be at least one of a volatile memory (for example, dynamic RAM (DRAM), static RAM (SRAM), or synchronous dynamic RAM (SDRAM)), and a non-volatile memory (for example, one time programmable ROM (OTPROM), programmable ROM (PROM), erasable and programmable ROM (EPROM), electrically erasable and programmable ROM (EEPROM), mask ROM, flash ROM, flash memory (for example, NAND flash memory, or NOR flash memory), a hard drive, and a solid state driver (SSD)).

The external memory 234 may include a flash drive, such as a compact flash (CF) drive, a secure digital (SD), a micro secure digital (micro-SD), a mini secure digital (mini-SD), an extreme digital (xD), a multi-media card (MMC), or a memory stick. The external memory 234 may be operatively and/or physically coupled to the electronic device 201 via various interfaces.

The sensor module 240 measures physical quantities or detects operational states of the electronic device 201, and converts the measured or detected information into electric signals. The sensor module 240 includes at least one of a gesture sensor 240A, a gyro sensor 240B, an atmospheric pressure sensor 240C, a magnetic sensor 240D, an acceleration sensor 240E, a grip sensor 240F, a proximity sensor 240G a red, green, blue (RGB) sensor 240H, a biometric sensor 240I, a temperature/humidity sensor 240J, an illumination sensor 240K, or an ultra violet (UV) sensor 240M. Additionally or alternatively, the sensor module 240 may include an electrical-nose (E-nose) sensor, an electromyogram (EMG) sensor, an electroencephaloeram (EEG) sensor, an electrocardiogram (ECG) sensor, an infrared (IR) sensor, an iris sensor, and/or a finger print sensor. The sensor module 240 may further include a control circuit for controlling one or more sensors included therein. The electronic device 201 may further include a processor configured to control the sensor module 240, as a part of or separately from the processor 210. Thus, while the processor 210 is in a sleep state, the control circuit may control the sensor module 240.

The input device 250 includes a touch panel 252, a (digital) pen sensor 254, a key 256, or an ultrasonic input device 258.

The touch panel 252 may operate in at least one of capacitive, resistive, infrared, and ultrasonic schemes. The touch panel 252 may further include a control circuit. The touch panel 252 may further include a tactile layer to thereby provide haptic feedback to the user.

The (digital) pen sensor 254 may include a detection sheet which is a part of the touch panel or is separately configured from the touch panel.

The key 256 may include a physical button, an optical key, or a keypad.

The ultrasonic input device 258 senses ultrasonic signals generated by an input tool using a microphone 288, and identifies data corresponding to the sensed ultrasonic signals.

The display 260 (for example, the display 160 of FIG. 1) includes a panel 262, a hologram device 264 and/or a projector 266.

The panel 262 may have the same configuration as or a similar configuration to the display 160 illustrated in FIG. 1. The panel 262 may be configured to be flexible, transparent, or wearable. The panel 262 and the touch panel 252 may be implemented as a single module.

The hologram device 264 utilizes an interference of light waves to provide a three-dimensional image in the air.

The projector 266 provides an image by projecting light on a screen. The screen may be positioned inside or outside the electronic device 201. The display 260 may further include a control circuit for controlling the panel 262, the hologram device 264, or the projector 266.

The interface 270 may include an HDMI 272, a USB 274, an optical interface 276, or a D-subminiature (D-sub) 278. The interface 270 may be included in the communication module 170 illustrated in FIG. 1. Additionally or alternatively, the interface 270 may include a mobile high-definition link (MHL) interface, an SD/multimedia card (MMC) interface, or an infrared data association (IrDA) interface.

The audio module 280 converts a sound to an electrical signal, and vice versa. At least a part of the components of the audio module 280 may be included in the I/O interface 150 illustrated in FIG. 1. The audio module 280 processes sound information input into, or output from a speaker 282, a receiver 284, an earphone 286, or the microphone 288.

The camera module 291 captures still images and a video. The camera module 291 may include one or more image sensors (for example, a front sensor or a rear sensor), a lens, an image signal processor (ISP), or a flash (for example, an LED or a xenon lamp).

The power management module 295 manages power of the electronic device 201. The power management module 295 may include a power management integrated circuit (PMIC), a charger IC, or a battery gauge. The PMIC may adopt wired and/or wireless charging. The wireless charging may be performed in a magnetic resonance scheme, a magnetic induction scheme, or an electromagnetic wave scheme, and may further include a coil loop, a resonance circuit, or a rectifier. The battery gauge measures a charge level, a voltage while charging, current, or temperature of the battery 296.The battery 296 may include a rechargeable battery and/or a solar battery.

The indicator 297 indicates specific states of the electronic device 201 or a part of the electronic device 201 (for example, the processor 210), for example, boot status, message status, or charge status.

The motor 298 converts an electrical signal into a mechanical vibration and generate vibrations or a haptic effect.

The electronic device 201 may include a processing device for supporting mobile TV (for example, a GPU). The processing device for supporting mobile TV processes media data compliant with digital multimedia broadcasting (DMB), digital video broadcasting (DVB), or MediaFLO.

According to an embodiment of the present disclosure, each of the above-described components of the electronic device 201 may include one or more parts and the name of the components may vary with the type of the electronic device. The electronic device 201 may be configured to include at least one of the afore-described components. Some components may be omitted from or added to the electronic device 201. A single entity may be configured by combining a part of the components of the electronic device 201, to perform the same functions of the components prior to the combining

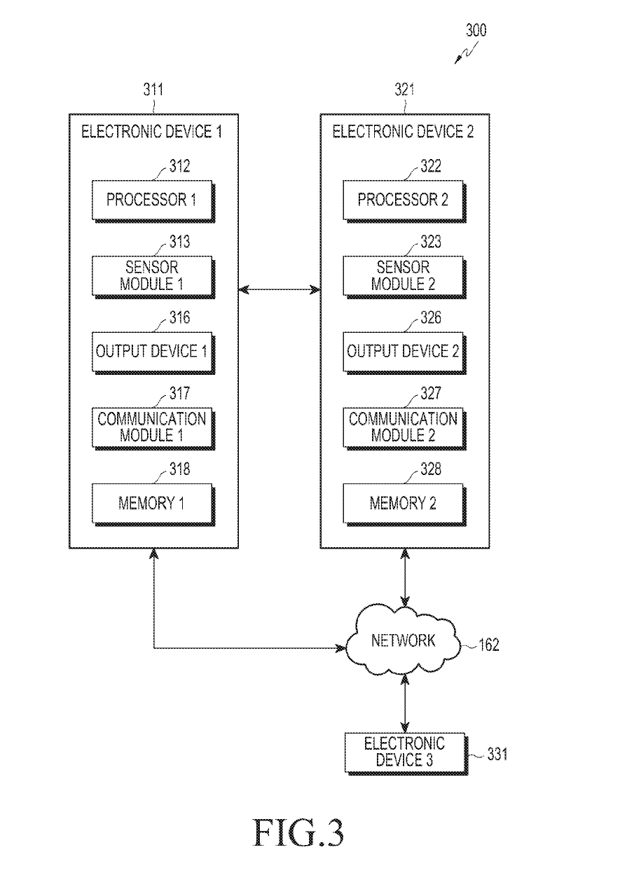

FIG. 3 is a block diagram of a communication system, according to an embodiment of the present disclosure.

Referring to FIG. 3, a communication system 300 is provided. The communication system 300 includes a first electronic device 311, a second electronic device 321, and a third electronic device 331 (each may be, for example, the electronic device 101 or 201).

The first electronic device 311 includes a first sensor module 313 (for example, the sensor module 240, the touch panel 252, the microphone 288, or the camera module 291) for receiving/detecting a biometric signal; a first output device 316 (for example, the I/O interface 150, the display 160 or 260, the speaker 282, or the motor 298) for outputting an image, sound, or vibration; a first communication module 317 (for example, the communication module 170 or 220) for transmitting or receiving data to or from an external electronic device; a first processor 312 (for example, the processor 120 or 210) operatively connected to the first sensor module 313, the first output device 316, and/or the first communication module 317, for executing functions of the first electronic device 312 by controlling all or a part of the first sensor module 313, the first output device 316, and/or the first communication module 317; and a first memory 318 (for example, the memory 130 or 230).

The second electronic device 321 includes a second sensor module 323 (as described above) for receiving/detecting a biometric signal; a second output device 326 for outputting an image, sound, or vibration; a second communication module 327 for transmitting or receiving data to or from an external electronic device; a second processor 322 operatively connected to the second sensor module 323, the second output device 326, and/or the second communication module 327, for executing functions of the second electronic device 321 by controlling all or a part of the second sensor module 323, the second output device 326, and/or the second communication module 327; and a second memory 328.

The third electronic device 331 may have the same configuration as or a similar configuration to the first electronic device 311 or the second electronic device 321.

The first electronic device 311, the second electronic device 321, and the third electronic device 331 may be connected to one another, directly or through a wired/wireless network 162, or may communicate with one another directly or through the wired/wireless network 162. For example, the first electronic device 311 and the second electronic device 321 may be connected to each other or communicate with each other, directly. For example, the first electronic device 311 and/or the second electronic device 321 may be connected to or communicate with the third electronic device 331 through the wired/wires network 162.

The biometric signal includes a signal representing a measurement about a user's body and/or a signal representing a vibration or sound generated directly from the body. For example, the biometric signal includes at least one of an EMG signal of a user, a signal representing a vibration generated from the user, a signal representing eye blinking of the user, a signal representing a touch/pressure applied to an electronic device by the user, or a signal representing a sound generated by the user.

The first electronic device 311 acquires a biometric signal of the user through the first sensor module 313.

For example, the acceleration sensor 240E of the first sensor module 313 may detect a motion of the first electronic device 311 (for example, rotation, acceleration, or vibration of the first electronic device 311) and output a signal representing the detected motion. The first sensor module 313 may include a separate first vibration sensor for outputting a signal representing a vibration of the first electronic device 311.

As another example, the biometric sensor 2401 of the first sensor module 313 may detect at least one of an EMG of the user, eye blinking of the user, or a finger print and output a signal representing the at least one of the EMG of the user, the eye blinking of the user, or the finger print.

As another example, the touch panel 252 of the first sensor module 313 may detect a touch/pressure applied to the first electronic device 311 by the user and output a signal representing the detected touch/pressure.

As another example, the microphone 288 of the first sensor module 313 may detect a sound generated by the user and output a signal representing the detected sound.

The second electronic device 321 acquires a biometric signal of a user through the second sensor module 323.

For example, the acceleration sensor 240E of the second sensor module 323 may detect a motion of the second electronic device 321 (for example, rotation, acceleration, or vibration of the second electronic device 321) and output a signal representing the detected motion. The second sensor module 313 includes a separate second vibration sensor for outputting a signal representing a vibration of the second electronic device 321.

As another example, the biometric sensor 240I of the second sensor module 323 may detect at least one of an EMG of a user, eye blinking of the user, or a finger print and output a signal representing the at least one of the EMG of the user, the eye blinking of the user, or the finger print.

As another example, the touch panel 252 of the second sensor module 323 may detect a touch/pressure applied to the second electronic device 321 by the user and output a signal representing the detected touch/pressure.

As another example, the microphone 288 of the second sensor module 323 may detect a sound generated by the user and output a signal representing the detected sound.

In an embodiment of the present disclosure, the first electronic device 311 may receive a biometric signal measured/generated by the second electronic device 321 from the second electronic device 321 through the first communication module 317.

If any of the first electronic device 311, the second electronic device 321, and the third electronic device 331 is referred to as an electronic device, the other electronic devices may be referred to as external electronic devices, hereinbelow.

The first processor 312 acquires a first biometric signal through the first sensor module 313 or the first communication module 317, detects, from the first biometric signal, a part of a first signal pattern including at least one of at least one signal of a first type or at least one signal of a second type, and executes a first function corresponding to the first signal pattern.

The first function may include at least one of execution, activation, or control of a function, service, or application; detection, output, or update of information or data; transmission or output of information, data, or a message; or connection to or disconnection from an external device. The first function may be executed by at least one of the first electronic device 311, the second electronic device 321, or the third electronic device 331.

The first-type signal is a short signal having a duration less than or equal to a first threshold, and a second-type signal is a long signal having a duration greater than or equal to the first threshold or a second threshold.

The first biometric signal includes at least one of an EMG signal of a user, a signal representing a vibration generated by the user, a signal representing eye blinking of the user, a signal representing a touch/pressure applied to the electronic device 311 by the user, or a signal representing a sound generated by the user.

The first processor 312 may receive the first biometric signal from the second electronic device 321 through the first communication module 317.

The first processor 312 compares a part of the first biometric signal including at least one of at least one signal of the first type or at least one signal of the second type with a first signal pattern pre-stored in the first memory 318 of the first electronic device 311, which is operatively connected to the first processor 312, and determines the part of the first biometric signal to be a part of the first signal pattern, if the part of the first biometric signal matches the pre-stored first signal pattern.

The first processor 312 detects feature signals satisfying a first condition from the first biometric signal, calculates a time interval between adjacent feature signals, determines a combination of the adjacent feature signals to be a first-type signal if the time interval satisfies a second condition, and determines the combination of the adjacent feature signals to be a second-type signal if the time interval satisfies a third condition.

The first processor 312 detects, from the first biometric signal, a first peak signal and a second peak signal that have a magnitude equal to or larger than a threshold, to calculate a time interval between the first peak signal and the second peak signal, determines a combination of the first and second peak signals to be a first-type signal if the time interval satisfies the first condition, and determines the combination of the first and second peak signals to be a second-type signal if the time interval satisfies the second condition.

The first condition may include a condition that the time interval is greater than or equal to a first threshold time and shorter than a second threshold time, a condition that the time interval is greater than or equal to the first threshold time and less than or equal to the second threshold time, a condition that the time interval is greater than the first threshold time and less than the second threshold time, or a condition that the time interval is greater than the first threshold time and less than or equal to the second threshold time. The second condition may include a condition that the time interval is greater than or equal to the second threshold time.

Alternatively, the first condition may include a condition that the time interval is less than or equal to the second threshold time, and the second condition may include a condition that the time interval is greater than or equal to the second threshold time; or a condition that the time interval is greater than or equal to a third threshold time.

Alternatively, the first condition may include a condition that the time interval is greater than or equal to the first threshold time and less than or equal to the second threshold time, and the second condition may include a condition that the time interval is greater than or equal to the second threshold time or greater than or equal to the third threshold time, and less than or equal to a fourth threshold time.

The first processor 312 may neglect the combination of the first and second peak signals, if the time interval is less than or equal to the first threshold time. That is, the first processor 312 may determine that the combination of the first and second peak signals is neither a first-type signal nor a second-type signal.

The first processor 312 may neglect the combination of the first and second peak signals, if the time interval does not satisfy either the first condition or the second condition. That is, the first processor 312 may determine that the combination of the first and second peak signals is neither a first-type signal nor a second-type signal.

The first processor 312 identifies a character sequence (or a character string) corresponding to the first signal pattern and transmits a message including the character sequence to the third electronic device 331 through the first communication module 317.

The first processor 312 identifies or detects a character sequence corresponding to the first signal pattern and outputs the character sequence through the first output device 316 or the second output device 326. For example, the first processor 312 detects the character sequence corresponding to the first signal pattern in a database of the first memory 318 or a database of the third electronic device 331.

The first processor 312 may identify or detect a character sequence of a first language corresponding to the first signal pattern, and convert the character sequence of the first language to a character sequence of a second language.

For example, the first processor 312 may detect the character sequence of the first language and the character sequence of the second language in the database of the first memory 318 or the database of the third electronic device 331. Alternatively, the first processor 312 may detect the character sequence of the first language in the database of the first memory 318, and detect the character sequence of the second language in the database of the third electronic device 331 through the first communication module 317.

The first processor 312 receives a response message to the message through the first communication module 317, and executes a second function based on response information included in the response message.

The second function may include at least one of execution, activation, or control of a function, service, or application; detection, output, or update of information or data; transmission of information, data, or a message; or connection to or disconnection from an external device. The second function may be executed by at least one of the first electronic device 311, the second electronic device 321, or the third electronic device 331.

The first processor 312 outputs the response information through the first output device 316 or the second output device 326.

The first processor 312 determines response information for the first biometric signal based on the first signal pattern, and outputs the response information through the first output device 316 or the second output device 326.

The response information may include at least one of a result of execution, activation, or control of a function, service, or application; a result of detection of information or data; a transmission result of or a response to information, data, or a message; or a result of connection to or disconnection from an external device. The response information may be output by the first electronic device 311 and/or the second electronic device 321.

The first processor 312 executes a command, service, or function corresponding to the first signal pattern, and acquires an execution result of the command, service, or function as the response information.

The first processor 312 transmits the response information to the second electronic device 321 through the first communication module 317.

The first processor 312 determines a second signal pattern including at least one of at least one signal of the first type corresponding to the response information or at least one signal of the second type corresponding to the response information, and outputs a response signal having the second signal pattern through the first output device 316 or the second output device 326.

The response signal may include at least one of a haptic signal, an auditory signal, or a visual signal.

The first processor 312 activates at least one function, service, mode, module, or component of the first electronic device 311 and/or the second electronic device 321.

The first processor 312 acquires a second biometric signal through the first sensor module 313 or the first communication module 317, and awaits reception of the first biometric signal during a threshold time, if a part of a third signal pattern pre-stored in the first memory is detected from the second biometric signal.

Alternatively, the first processor 312 acquires a second biometric signal through the first sensor module 313 or the first communication module 317, and awaits reception of the first biometric signal during a threshold time, if a third signal pattern including at least one of at least one signal of the first type or at least one signal of the second type is detected from the second biometric signal.

The first processor 312 activates at least one function, service, mode, module, or component of the first electronic device 311 and/or the second electronic device 321, which is needed for reception of the first biometric signal, if the third signal pattern is detected from the second biometric signal.

The first function may be executed based on information (or a database) indicating a mapping relationship between a plurality of signal patterns and a plurality of functions, commands, services, or character sequences.

The first processor 312 receives the information indicating a mapping relationship between a plurality of signal patterns and a plurality of functions, commands, services, or character sequences from the third electronic device 331 through the first communication module 317, and detects a part of the first signal pattern based on the received information.

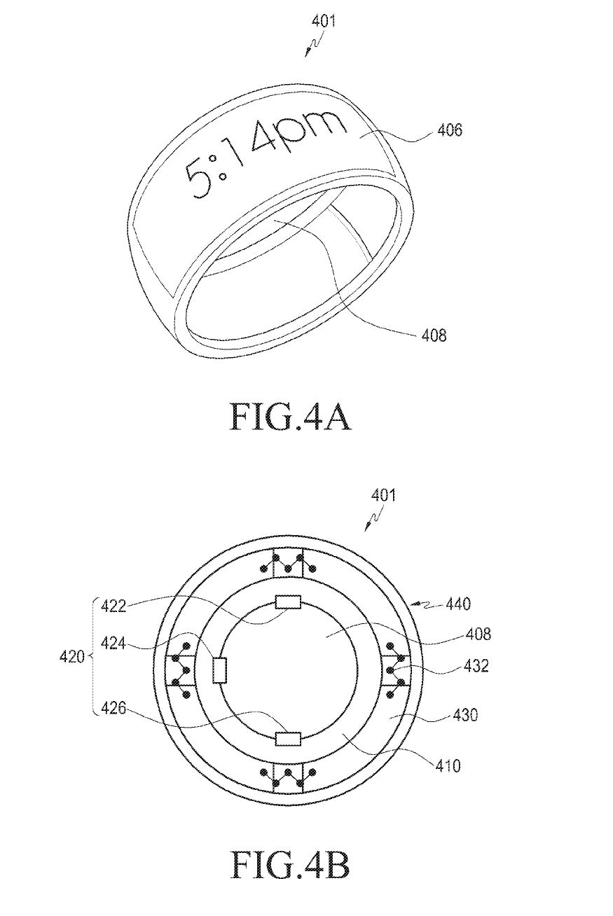

FIGS. 4A and 4B illustrate a second electronic device, according to an embodiment of the present disclosure.

Referring to FIG. 4A, a second electronic device 401 (for example, the second electronic device 321 of FIG. 3) may be shaped into a ring and worn around a user's finger through a center hole 408. The second electronic device 401 includes a display 406 forming a part of a second output device (for example, the second output device 326 of FIG. 3).

Referring to FIG. 4B, the second electronic device 401 includes an EMG sensor 420 forming at least a part of a second sensor module (for example, the second sensor module 323 of FIG. 3), for detecting muscular contraction/relaxation of a user and outputting an EMG signal representing the muscular contraction/relaxation. The second electronic device 401 may further include a second communication module (for example, the second communication module 327 of FIG. 3) for transmitting a biometric signal corresponding to the EMG signal to a first electronic device (for example, the first electronic device 311 of FIG. 3).

The second electronic device 401 includes a ring-shaped elastic member 410 that directly contacts a user's finger and is deformable; a first electrode 422, a second electrode 424, and a third electrode 426 of the EMG sensor 420, which are arranged on an inner surface of the elastic member 410; a flexible printed circuit board (FPCB) 430 that is arranged around an outer periphery of the elastic member 410 and has a plurality of divided parts; a plurality of cables 432 for electrically connecting the plurality of parts of the FPCB 430 to one another; and an insulating protection member 440 arranged around an outer periphery of the FPCB 430.

The FPCB 430 or the EMG sensor 420 may include a voltage application circuit for applying a voltage to at least two of the first electrode 422, the second electrode 424, and the third electrode 426, and a voltage detection circuit for outputting a signal indicating a voltage between the at least two electrodes (or a changed part(s) of the signal) as an EMG signal. The FPCB 430 may further include at least one of a ground circuit for connecting one of the first electrode 422, the second electrode 424, and the third electrode 426 to a ground, and an amplifier for amplifying the EMG signal.

For example, if a user cups or bends his or her hand, a voltage between the at least two electrodes may be changed a relatively large amount in view of the resulting muscular contraction. If the user spreads the hand, the voltage between the at least two electrodes may be changed a relatively small amount in view of the resulting muscular relaxation. Accordingly, a muscular contraction/relaxation state may be determined based on a variation in the voltage between the at least two electrodes.

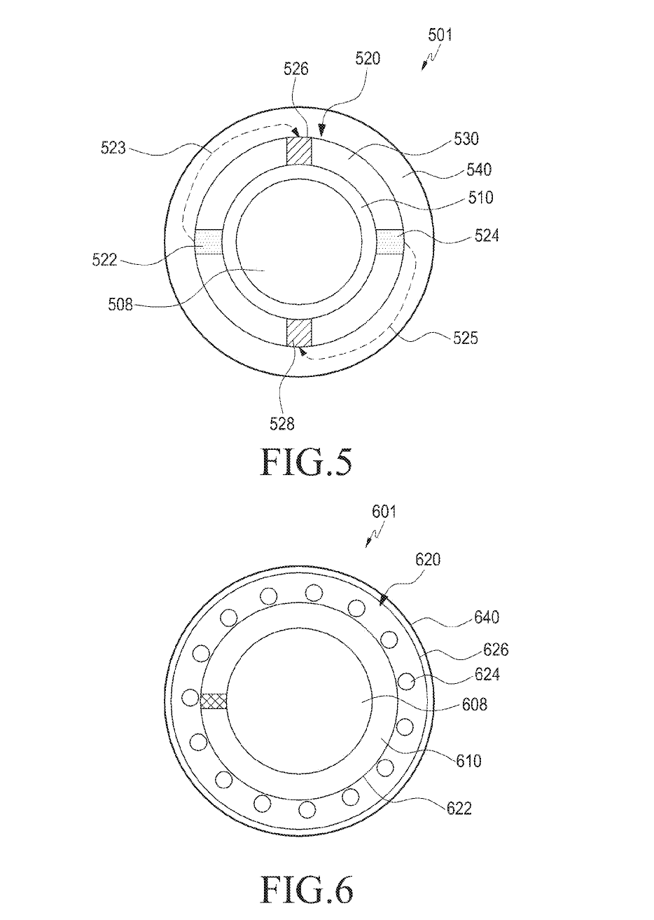

FIG. 5 illustrates a second electronic device, according to an embodiment of the present disclosure.

Referring to FIG. 5, a second electronic device 501 may be shaped into a ring and worn around a user's finger through a center hole 508.

The second electronic device 501 includes a touch sensor 520 forming at least a part of a second sensor module, for detecting a touch/hovering of a user and outputting a touch/hovering signal representing the user's touch or hovering. The second electronic device 501 may further include a second communication module for transmitting a biometric signal corresponding to the touch/hovering signal to a first electronic device.

The second electronic device 501 includes a ring-shaped elastic member 510 that directly contacts a user's finger and is deformable; an FPCB 530 arranged around an outer periphery of the elastic member 510; a first electrode 522, a second electrode 524, a third electrode 526, and a fourth electrode 528 of the touch sensor 520, which are arranged on the FPCB 530; and an insulating protection member 540 (for example, protection glass) arranged around an outer periphery of the FPCB 530.

The FPCB 530 or the touch sensor 520 may include a voltage application circuit for applying a voltage to each of the first electrode 522 and the second electrode 524, and a voltage detection circuit for outputting a signal indicating a voltage of each of the third electrode 526 and the fourth electrode 528 (or a changed part(s) of the signal) as a touch/hovering signal.

For example, if an electrical field 523 is formed between the first electrode 522 and the third electrode 526 and a user's finger contacts the protection member 540, the electrical field 523 between the first electrode 522 and the third electrode 526 may be changed, thus changing an output voltage of the third electrode 526. Likewise, if an electrical field 525 is formed between the second electrode 524 and the fourth electrode 528 and a user's finger contacts the protection member 540, the electrical field 525 between the second electrode 524 and the fourth electrode 528 may be changed, thus changing an output voltage of the fourth electrode 528. Accordingly, the presence or absence of a touch/hovering and/or the position of the touch/hovering may be determined based on a variation in a voltage between the first electrode 522 and the third electrode 526 or a variation in a voltage between the second electrode 524 and the fourth electrode 528.

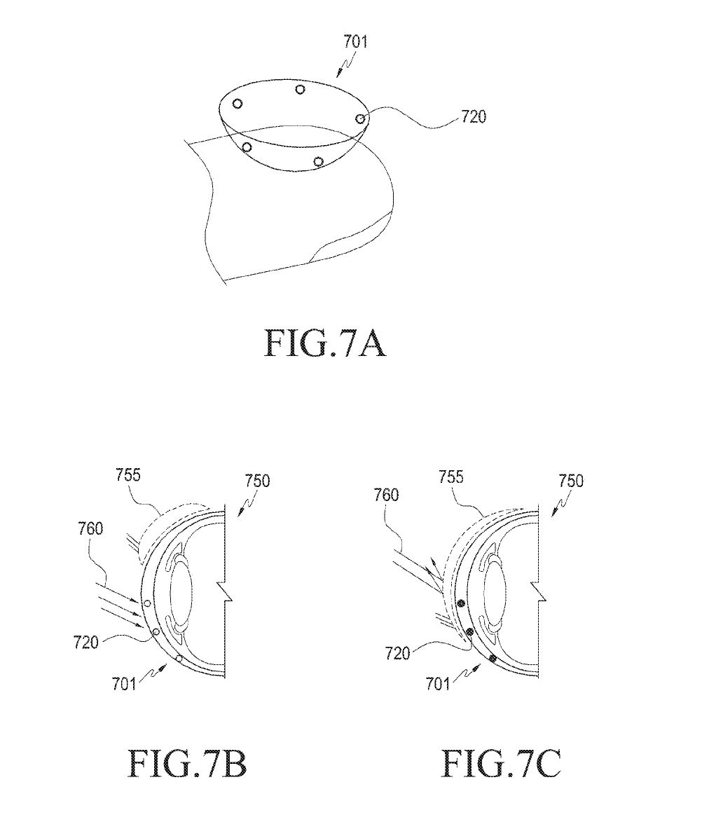

FIG. 6 illustrates a second electronic device, according to an embodiment of the present disclosure.

Referring to FIG. 6, a second electronic device 601 may be shaped into a ring and worn around a user's finger through a center hole 608.

The second electronic device 601 includes a touch sensor 620 forming at least a part of a second sensor module, for detecting a touch of a user on the second electronic device 601 and outputting a touch signal representing the user's touch. The second electronic device 601 may further include a second communication module for transmitting a biometric signal corresponding to the touch signal to a first electronic device.

The second electronic device 601 includes a ring-shaped elastic member 610 that directly contacts a user's finger and is deformable, the touch sensor 620 arranged around an outer periphery of the elastic member 610, and an insulating protection member 640 (for example, protection glass) arranged around an outer periphery of the touch sensor 620. The touch sensor 620 includes a first electrode 622 arranged around the outer periphery of the elastic member 610, and a second electrode 626 spaced from the first electrode 622 by means of a plurality of spacers 624. For example, the first electrode 622 may be a coating layer deposited on an outer surface of the elastic member 610, and the second electrode 626 may be a coating layer deposited on an inner surface of the insulating protection member 640.

The second electronic device 601 or the touch sensor 620 may include a voltage application circuit for applying a voltage between the first electrode 622 and the second electrode 626, and a voltage detection circuit for outputting a signal indicating a voltage between the first electrode 622 and the second electrode 626 (or a changed part(s) of the signal) as a touch signal.

For example, if the user's finger presses the protection member 640, the second electrode 626 is deformed toward the first electrode 622, thus changing the voltage between the first electrode 622 and the second electrode 626. Accordingly, the presence or absence of a touch and/or the position of the touch may be determined based on a variation in the voltage between the first electrode 622 and the second electrode 626.

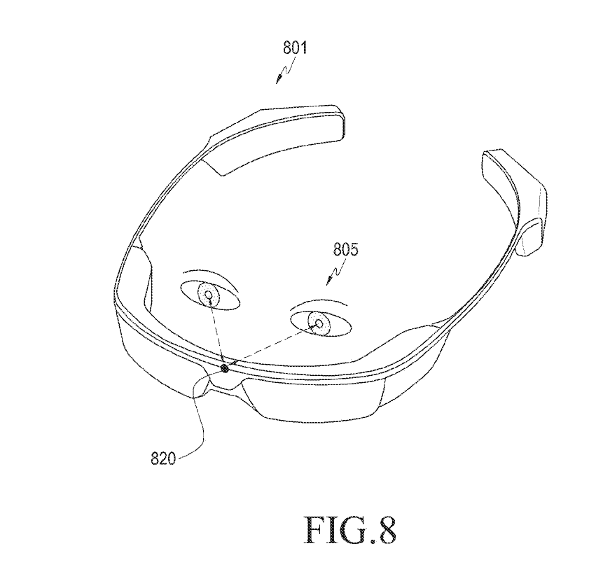

FIGS. 7A, 7B, and 7C illustrate a second electronic device according to an embodiment.

Referring to FIG. 7A, for example, a second electronic device 701 may be shaped into a contact lens and worn on an eye of a user.

The second electronic device 701 includes at least one illumination sensor 720 forming at least a part of a second sensor module, for detecting eye blinking of the user or outputting a signal representing the eye blinking of the user. The second electronic device 701 may further include a second communication module for transmitting a biometric signal representing the eye blinking to a first electronic device.

The second electronic device 701 or the illumination sensor 720 may include a voltage application circuit for applying a voltage to the illumination sensor 720 and a voltage detection circuit for outputting a signal representing an output voltage of the illumination sensor 720 (or a changed part(s) of the signal) as an eye blinking signal.

Referring to FIG. 7B, when the user opens an eye 750, that is, when the eye 750 is not closed by an eyelid 755, external light will be incident on the illumination sensor 720 of the second electronic device 701.

Referring to FIG. 7C, when the user closes the eye 750, that is, when the eye 750 is closed by the eyelid 755, external light will not be incident on the illumination sensor 720 of the second electronic device 701.

The voltage of a signal output from the illumination sensor 720 may be changed according to the intensity or amount of light incident on the illumination sensor 720. Therefore, it may be determined whether an eye blinks based on a variation in the voltage of the signal output from the illumination sensor 720.

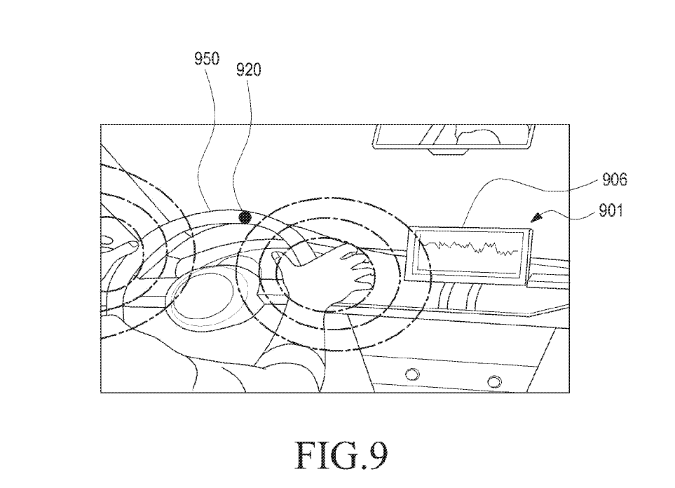

FIG. 8 illustrates a second electronic device, according to an embodiment of the present disclosure.

Referring to FIG. 8, a second electronic device 801 may be shaped into glasses and worn around the face or head of a user.

The second electronic device 801 includes at least one camera 820 forming at least a part of a second sensor module, for detecting blinking of the eyes 805 of the user. The second electronic device 801 may further include a second communication module for transmitting a biometric signal representing the eye blinking to a first electronic device.

The second electronic device 801 may include a second processor for sensing the eyes and eye blinking of the user from an image captured by the camera 820 and generating and outputting a signal representing the eye blinking.

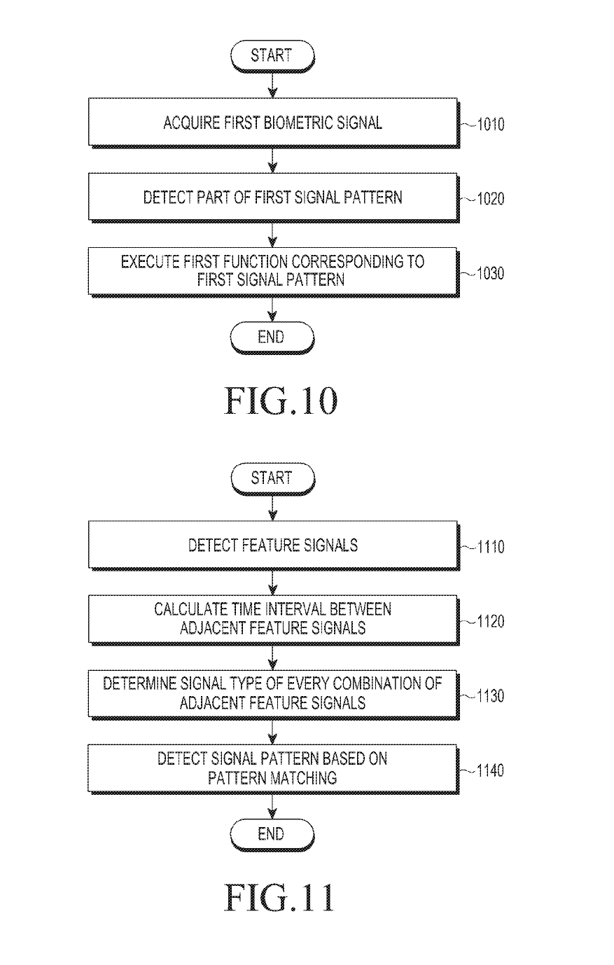

FIG. 9 illustrates a second electronic device, according to an embodiment of the present disclosure.

Referring to FIG. 9, a second electronic device 901 may be an in-vehicle information system installed in a vehicle.

The second electronic device 901 includes at least one vibration/touch sensor 920 forming at least a part of a second sensor module, for detecting a vibration/touch generated by a user or outputting a vibration/touch signal representing the vibration/touch. For example, the vibration/touch sensor 920 may be installed on a steering wheel of the vehicle.

The second electronic device 901 includes a display 906 that forms a part of a second output device. The second electronic device 901 may further include a second communication module for transmitting a biometric signal corresponding to the vibration/touch signal to a first electronic device. For example, the second electronic device 901 may receive the vibration/touch signal from the vibration/touch sensor 920 by wire or wirelessly through the second communication module.

The second electronic device 901 or the vibration/touch sensor 920 may include a voltage detection circuit for outputting a signal representing an output voltage of the vibration/touch sensor 920 (or a changed part(s) of the signal) as a vibration/touch signal.

The voltage of a signal output from the vibration/touch sensor 920 may be changed according to a vibration/touch of the vibration/touch sensor 920. Therefore, it may be determined whether a vibration/touch has been generated based on a variation in the voltage of the signal output from the vibration/touch sensor 920.

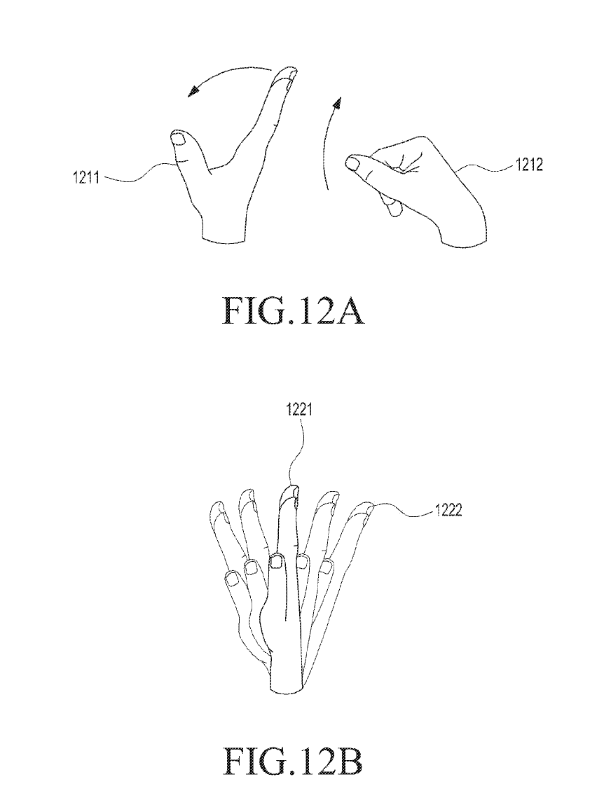

FIG. 10 is a flowchart of a method for executing a function based on a biometric signal, according to an embodiment of the present disclosure.

Referring to FIG. 10, a method for executing a function based on a biometric signal in the first electronic device 311 is provided. The method for executing a function based on a biometric signal in the first electronic device 311 may be performed by at least one of the first electronic device 311, and a first controller, or the first processor 312 of the first electronic device 311.

In step 1010, the first electronic device 311 acquires a first biometric signal.

The first biometric signal may include at least one of a signal representing a measurement from a user's body and/or a signal representing a detected vibration or sound generated directly from the body. For example, the first biometric signal may be an EMG signal of the user, a signal representing a vibration generated by the user, a signal representing eye blinking of the user, a signal representing a touch/pressure applied to an electronic device by the user, or a signal representing a sound generated by the user.

The first electronic device 311 acquires the first biometric signal using the first sensor module 313.

The first electronic device 311 receives a biometric signal measured or generated by the second electronic device 321 from the second electronic device 321 through the first communication module 317.

In step 1020, the first electronic device 311 detects, from the first biometric signal, a part of a first signal pattern including at least one of at least one signal of the first type or at least one signal of the second type.

The first-type signal is a short signal having a duration less than or equal to a first threshold, and a second-type signal is a long signal having a duration greater than or equal to the first threshold or a second threshold.

The first electronic device 311 compares a part of the first biometric signal including at least one of at least one signal of the first type or at least one signal of the second type with a first signal pattern pre-stored in a first memory 318 of the first electronic device 311, and determines the part of the first biometric signal to be a part of the first signal pattern, if the part of the first biometric signal matches the pre-stored first signal pattern.

In step 1030, the first electronic device 311 executes a first function corresponding to the first signal pattern.

The first function may include at least one of execution, activation, or control of a function, service, or application; detection, output, or update of information or data; transmission of information, data, or a message, or connection to or disconnection from an external device. For example, the first function may be executed by at least one of the first electronic device 311, the second electronic device 321, or the third electronic device 331.

The first memory 318 pre-stores information (or a database) indicating a mapping relationship between a plurality of signal patterns and a plurality of functions, commands, services, or character sequences, and the first electronic device 311 may determine the first function based on the information (or database).

The information may have various data structures. For example, the information may be represented as a plurality of records that describe a plurality of information or data elements and a relationship among the plurality of information or data elements.

The first memory 318 stores the information indicating a mapping relationship between a plurality of signal patterns and a plurality of functions, commands, services, or character sequences in the form of a plurality of records as illustrated in Table 1.

TABLE 1

| Pattern ID | Pattern description | Function | Character sequence |
|---|---|---|---|
| A1 | B1 | C1 | D1 |
| A2 | B2 | C2 | D2 |
| A3 | B3 | C3 | D3 |
| A4 | B4 | C4 | D4 |
| . . . | . . . | . . . | . . . |
| An | Bn | Cn | Dm |

Pattern ID Ai (1≦i≦n, n is an integer greater than or equal to 1) represents unique identification information about a signal pattern, Pattern description Bi represents a description of a signal pattern, Function Ci represents a function, command, service, or application corresponding to a signal pattern, and Character sequence Di represents a character sequence corresponding to a signal pattern or at least one of an execution parameter, input variable, and setting value of a function, command, service, or application. Each field (that is, each of Pattern ID Ai, Pattern description Bi, Function Ci, and Character sequence Di) of a record may have one or more values, and each value may be a constant, coordinates, a vector, a matrix, text, or an address.

For example, signal patterns may be mapped to character sequences as illustrated in Table 2.

TABLE 2

| Pattern | |
|---|---|
| description | Character sequence |
| * * * | Please, help me urgently. |
| - * - * | In a meeting. |
| - * * | Driving. |
| * - * * | At class. |
| - | Talking. |
| - - | Watching a movie. |

In Table 2, for example, * may be a first-type signal (for example, a short signal having a duration equal to or shorter than a first threshold), and − may be a second-type signal (for example, a long signal having a duration equal to or longer than the first threshold or a second threshold).

The mapping relationship between signal patterns and character sequences may be set by a user. For example, the first electronic device may receive a signal pattern and a character sequence from the user through a first input device (for example, the I/O interface 150, the input device 250, or the display 160) and store the received signal pattern and character sequence in the first memory 318 (or a database).

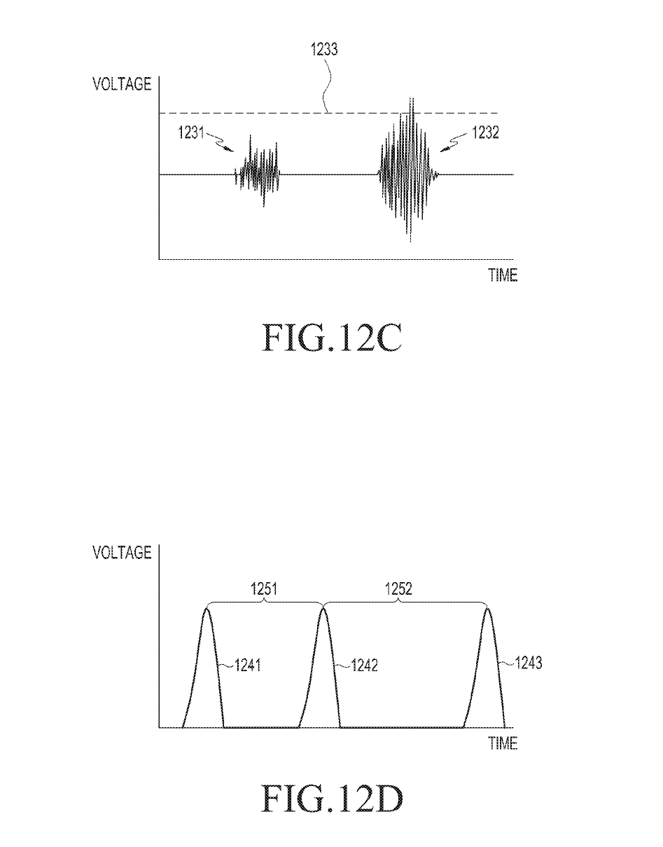

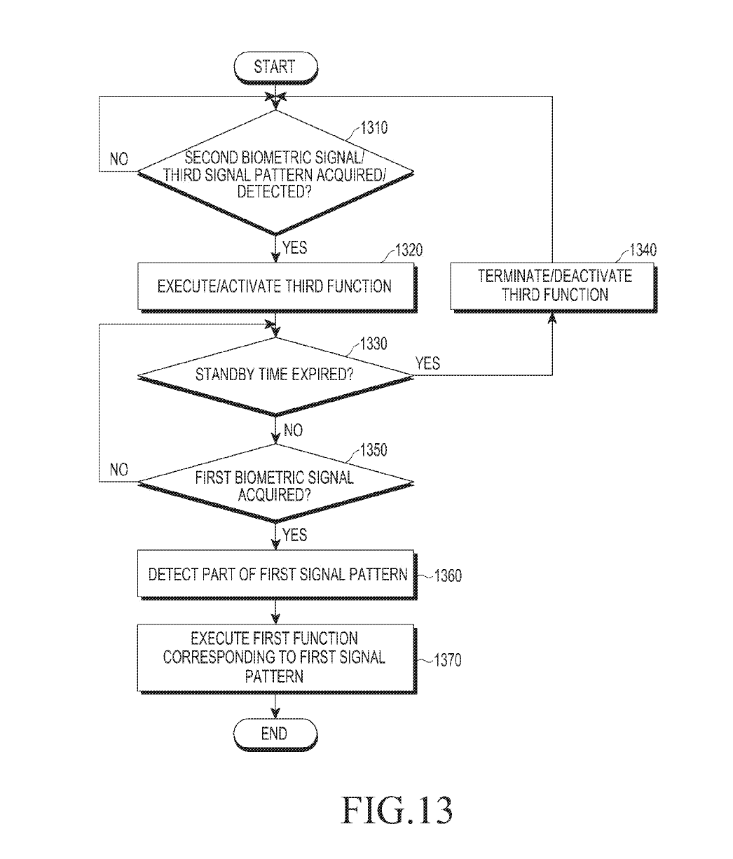

FIG. 11 is a flowchart of a method for detecting a signal pattern, according to an embodiment of the present disclosure. FIGS. 12A, 12B, 12C, and 12D are illustrate a method for detecting a signal pattern, according to an embodiment of the present disclosure.

Referring to FIG. 11, a method for detecting a signal pattern in the first electronic device 311 is provided. The method for detecting a signal pattern in the first electronic device 311 may be performed by at least one of the first electronic device 311, and a first controller, or the first processor 312 of the first electronic device 311.

In step 1110, the first electronic device 311 detects, from a biometric signal, feature signals (for example, peak signals) satisfying a third condition (for example, a magnitude greater than or equal to or less than or equal to a third threshold, or the accuracy of matching to information preset in the first electronic device 311, greater than or equal to the third threshold).

The first electronic device 311 detects, from the biometric signal, peak signals having magnitudes (for example, voltages, currents, power, or levels) greater than or equal to the third threshold.

The first electronic device compares the biometric signal with a third signal pattern pre-stored in the first memory 318 of the first electronic device 311, and if a part of the biometric signal matches the pre-stored third signal pattern, determines or detects the part of the biometric signal as a feature signal.

The first electronic device 311 may determine that a combination of two feature signals corresponds to one feature signal.

In step 1120, the first electronic device 311 calculates a time interval between adjacent feature signals.

In an embodiment, the first electronic device 311 calculates a time interval between adjacent peak signals.

The first electronic device 311 calculates a duration of a combination of two adjacent feature signals.

In step 1130, the first electronic device 311 determines the signal type of every combination of adjacent feature signals.

If the time interval (or the duration) satisfies a first condition, the first electronic device 311 determines the combination of the adjacent feature signals (or adjacent peak signals) to be a first-type signal. If the time interval satisfies a second condition, the first electronic device 311 determines the combination of the adjacent feature signals (or adjacent peak signals) to be a second-type signal.

The first condition may include a condition that the duration is less than or equal to a first threshold, and the second condition may include a condition that the duration is greater than or equal to the first threshold or a second threshold.

The first condition may include a condition that the time interval is greater than or equal to a first threshold time and less than or equal to a second threshold time, and the second condition may include a condition that the time interval is greater than or equal to the second threshold time.

The first condition may include a condition that the time interval is less than or equal to the second threshold time, and the second condition may include a condition that the time interval is greater than or equal to the second threshold time or greater than or equal to a third threshold time.

The first condition may include a condition that the time interval is greater than or equal to the first threshold time and less than or equal to the second threshold time, and the second condition may include a condition that the time interval is greater than or equal to the second threshold time or greater than or equal to the third threshold time, and less than or equal to a fourth threshold time.

The first electronic device 311 may neglect the combination of the adjacent feature signals, if the time interval is less than or equal to the first threshold time.

In step 1140, the first electronic device 311 detects a signal pattern based on pattern matching.

The first electronic device 311 compares a part of the biometric signal including at least one of at least one signal of the first type or at least one signal of the second type with a first signal pattern pre-stored in the first memory 318. If the part of the biometric signal matches the pre-stored first signal pattern, the first electronic device 311 determines or detects the part of the biometric signal as a part of the first signal pattern.

Steps 1110 to 1140 may be performed by the second electronic device 321.

Referring to FIG. 12A, an EMG signal having a relatively small magnitude may be detected in view of muscular relaxation, from a spread hand 1211 and/or finger. An EMG signal having a relatively large magnitude may be detected in view of muscular contraction, from a cupped hand 1212 and/or finger.

Referring to FIG. 12B, an EMG signal having a relatively small magnitude may be detected in view of muscular relaxation, from a hand 1221 with an extended wrist. An EMG signal having a relatively large magnitude may be detected in view of muscular contraction, from a hand 1222 with a bent wrist.

Referring to FIG. 12C, a first EMG signal part 1231 having a relatively small magnitude (or a magnitude less than a threshold voltage 1233) representing muscular relaxation in the case of hand spreading or wrist extension, and a second EMG signal part 1232 having a relatively large magnitude (or a magnitude greater than or equal to the threshold voltage 1233) representing muscular contraction in the case of hand cupping or wrist bending may be detected, respectively.

Referring to FIG. 12D, regarding a time interval between a first feature signal 1241 and a second feature signal 1242 detected from a biometric signal and a time interval between the second feature signal 1242 and a third feature signal 1243 detected from the biometric signal, a combination of the first and second feature signals 1241 and 1242 satisfying the first condition may be determined or detected as a first-type signal 1251, and a combination of the second and third feature signals 1242 and 1243 satisfying the second condition may be determined or detected as a second-type signal 1252.

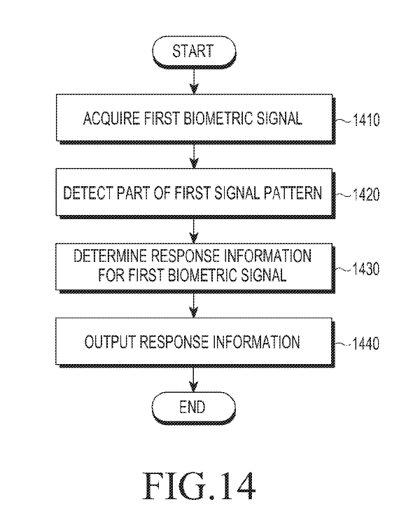

FIG. 13 is a flowchart of a method for executing a function based on a biometric signal, according to an embodiment of the present disclosure.

Referring to FIG. 13, a method for executing a function based on a biometric signal in the first electronic device 311 is provided. The method for executing a function based on a biometric signal in the first electronic device 311 may be performed by at least one of the first electronic device 311, and a first controller or the first processor 312 of the first electronic device 311.

In step 1310, the first electronic device 311 determines whether a second biometric signal/a third signal pattern has been acquired or detected. If the second biometric signal/the third signal pattern has been acquired or detected, the first electronic device 311 performs step 1320. On the other hand, if the second biometric signal/the third signal pattern has not been acquired or detected, the first electronic device 311 periodically repeats step 1310.

For example, the first electronic device 311 may set the second biometric signal or the third signal pattern as a trigger signal for triggering a method for executing a first function based on a first biometric signal.

The first electronic device 311 pre-stores, in a first memory 318 of the first electronic device 311, information about a second biometric signal of a different type from the first biometric signal and/or information about a third signal pattern which has the same type as or a different type from the first biometric signal and is different from a first signal pattern. For example, the first electronic device 311 pre-stores a third signal pattern including at least one first-type signal or at least one second-type signal in the first memory 318.

The first electronic device 311 acquires the second biometric signal through a first component (for example, the touch panel 252) of the first sensor module 313, and acquires the first biometric signal through a second component (for example, the accelerometer sensor 240E) of the first sensor module 313.

In step 1320, the first electronic device 311 executes or activates a third function. The third function includes a function for awaiting reception of the first biometric signal (or a function for activating a timer) during a threshold time.

The third function may include, in addition to or instead of the waiting function, at least one of execution, activation, or control of at least one other function, service, or application of the first electronic device 311; detection, output, or update of information or data; transmission or output of information, data, or a message; or connection to or disconnection from an external device.

The first electronic device 311 activates the second component (for example, the accelerometer sensor 240E) of the first sensor module 313 needed to acquire the first biometric signal.

The first electronic device 311 may switch at least one component of the first electronic device from an inactive state (or sleep mode) to an active state (or normal mode) or decrease an activation/deactivation period of the at least one component.

In the sleep mode or inactive state, for example, the component may be placed in a state in which it is not capable of performing at least a part of its function that it is capable of performing in the normal mode or active state.

For example, in the normal mode or active state, a camera may be placed in a power/display on state, a state in which it generates and/or displays a preview image, or a state in which it is capable of capturing an image. On the other hand, in the sleep mode or inactive state, the camera may be placed in a power/display off state, a state in which it does not generate and/or display a preview image, or a state in which it is not capable of capturing an image.

For example, in the normal mode or active state, a display may be in a power/display on state. On the other hand, the display may be in a power/display off state in the sleep mode or inactive state.

The first electronic device 311 may output a signal (for example, at least one of a haptic signal, an auditory signal, or a visual signal) indicating to a user that the first electronic device 311 is in a standby state through the first output device 316 and/or the second output device 326.

In step 1330, the first electronic device 311 determines whether a standby time has expired. If the standby time has expired, the first electronic device 311 performs step 1340. If the standby time has not expired, the first electronic device 311 performs step 1350.

In step 1340, the first electronic device 311 may terminates or deactivates the third function.

The first electronic device 311 may deactivate the second component (for example, the accelerometer sensor 240E) of the first sensor module 313 needed to acquire the first biometric signal.

In step 1350, the first electronic device 311 determines whether the first biometric signal has been acquired. Upon acquisition of the first biometric signal, the first electronic device 311 performs step 1360. If the first biometric signal has not been acquired, the first electronic device 311 performs step 1330 again.

The first biometric signal may include a signal representing a measurement about a user's body and/or a signal representing a detected vibration or sound generated directly from the body. For example, the first biometric signal may include at least one of an EMG signal of a user, a signal representing a vibration generated from the user, a signal representing eye blinking of the user, a signal representing a touch/pressure applied to the first electronic device or the second electronic device 321 by the user, or a signal representing a sound generated by the user.

The first electronic device 311 acquires the first biometric signal through the first sensor module 313.

The first electronic device 311 receives a biometric signal measured or generated by the second electronic device 321 from the second electronic device 321 through the first communication module 317.

In step 1360, the first electronic device 311 detects, from the first biometric signal, a part of a first signal pattern including at least one of at least one signal of the first type or at least one signal of the second type.

The first-type signal is a short signal having a duration less than or equal to a first threshold, and a second-type signal is a long signal having a duration greater than or equal to the first threshold or a second threshold.

The first electronic device 311 compares a part of the first biometric signal pattern including at least one of at least one signal of the first type or at least one signal of the second type with a first signal pattern pre-stored in the first memory 318, and determines the part of the first biometric signal to be a part of the first signal pattern, if the part of the first biometric signal matches the pre-stored first signal pattern.

In step 1370, the first electronic device 311 executes a first function corresponding to the first signal pattern.

The first function includes at least one of execution, activation, or control of a function, service, or application; detection, output, or update of information or data; transmission of information, data, or a message; or connection to or disconnection from an external device. For example, the first function may be executed by at least one of the first electronic device 311, the second electronic device 321, or the third electronic device 331.

Steps 1310 to 1370 may be performed by the second electronic device 321.

Steps 1310 to 1340 may be performed by the second electronic device 321, and steps 1350, 1360, and 1370 may be performed by the third electronic device 331.

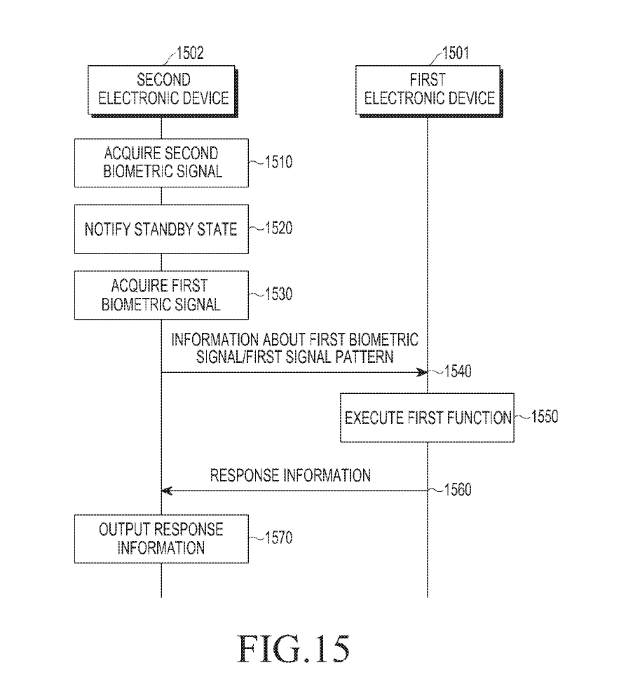

FIG. 14 is a flowchart of a method for executing a function based on a biometric signal, according to an embodiment of the present disclosure. A method for executing a function based on a biometric signal in the first electronic device 311 is provided. The method for executing a function based on a biometric signal in the first electronic device 311 may be performed by at least one of the first electronic device 311, and a first controller or the processor 312 of the first electronic device 311.

In step 1410, the first electronic device 311 acquires a first biometric signal.

The first electronic device 311 acquires the first biometric signal through the first sensor module 313.

The first electronic device 311 receives a biometric signal measured or generated by the second electronic device 321 from the second electronic device 321 through the first communication module 317.

In step 1420, the first electronic device 311 detects, from the first biometric signal, a part of a first signal pattern including at least one of at least one signal of the first type or at least one signal of the second type.

The first-type signal is a short signal having a duration less than or equal to a first threshold, and a second-type signal is a long signal having a duration greater than or equal to the first threshold or a second threshold.

The first electronic device 311 compares a part of the first biometric signal including at least one of at least one signal of the first type or at least one signal of the second type with a first signal pattern pre-stored in the first memory 318 of the first electronic device 311, and determines the part of the first biometric signal to be a part of the first signal pattern, if the part of the first biometric signal matches the pre-stored first signal pattern.

In step 1430, the first electronic device 311 determines response information for the first biometric signal based on the first signal pattern.

The first electronic device 311 executes a command, service, or function corresponding to the first signal pattern. The first electronic device 311 acquires a result of executing the command, service, or function as the response information.

The first electronic device 311 identifies a character sequence corresponding to the first signal pattern, and transmits a message including the character sequence to the third electronic device 331. The first electronic device 311 receives a response message to the message from the third electronic device 331 and executes a second function corresponding to response information included in the response message. The second function may include at least one of execution, activation, or control of a function, service, or application; detection, output, or update of information or data; transmission of information, data, or a message; or connection to or disconnection from an external device. For example, the second function may be executed by at least one of the first electronic device 311, the second electronic device 321, or the third electronic device 331.

In step 1440, the first electronic device 311 outputs the response information.

The first electronic device 311 transmits the response information to the second electronic device 321.

The first electronic device 311 determines a second signal pattern including at least one of at least one signal of the first type corresponding to the response information or at least one signal of the second type, corresponding to the response information. The first electronic device 311 outputs a response signal having the second signal pattern through the first output device 316 and/or the second output device 326. For example, the response signal includes at least one of a haptic signal, an auditory signal, or a visual signal.

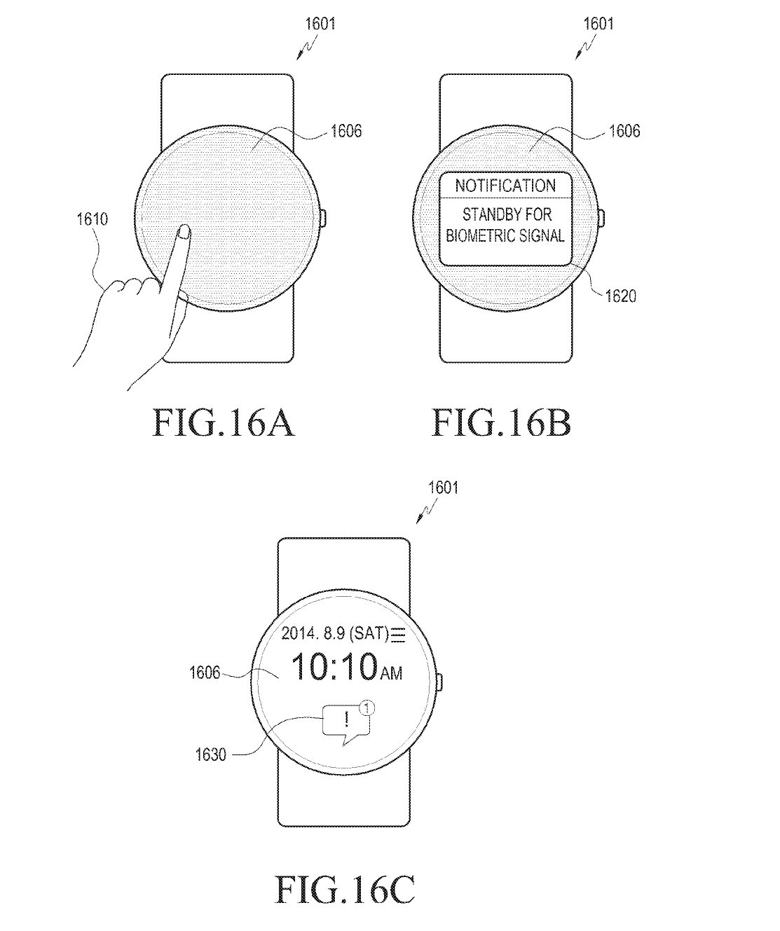

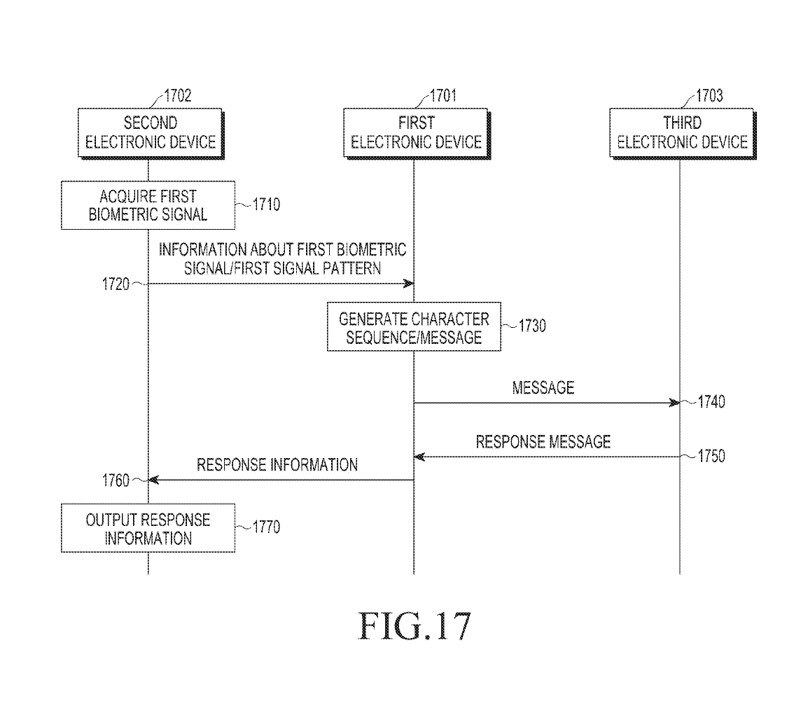

FIG. 15 is a signal flow diagram of a method for executing a function based on a biometric signal, according to an embodiment of the present disclosure. FIGS. 16A, 16B, and 16C illustrate a method for executing a function based on a biometric signal, according to an embodiment of the present disclosure.

Referring to FIG. 15, a method for executing a function based on a biometric signal performed by a first electronic device 1501 and the second electronic device 1502 is provided.

In step 1510, the second electronic device 1502 acquires a second biometric signal. For example, the second electronic device 1502 may set the second biometric signal or a third signal pattern as a trigger signal for triggering a method for executing a first function based on a first biometric signal.

The second electronic device 1502 pre-stores, in a second memory 328 of the second electronic device 1502, information about a second biometric signal of a different type from the first biometric signal and/or information about a third signal pattern which has the same type as or a different type from the first biometric signal and is different from a first signal pattern. For example, the second electronic device 1502 may pre-store a third signal pattern including at least one first-type signal or at least one second-type signal in the second memory 328.

The second electronic device 1502 acquires the second biometric signal through a first component (for example, the touch panel 252) of the second sensor module 323, and acquires the first biometric signal through a second component (for example, the accelerometer sensor 240E) of the second sensor module 323.

In step 1520, the second electronic device 1502 outputs a signal (for example, at least one of a haptic signal, an auditory signal, or a visual signal) indicating to a user that the second electronic device 1502 is in a standby state through the first output device 316 and/or the second output device 326, in response to the acquisition or detection of the second biometric signal/the third signal pattern.

The second electronic device 1502 activates a second component (for example, the accelerometer sensor 240E) of the first sensor module 313 needed to acquire the first biometric signal.

The second electronic device 1502 may switch at least one component (for example, the second component of the first sensor module 313) of the second electronic device 1502 from an inactive state (or sleep mode) to an active state (or normal mode) or decrease an activation or deactivation period of the at least one component.

The second electronic device 1502 transmits a signal indicating that the second electronic device 1502 is in a standby state, to the first electronic device 1501.

In step 1530, the second electronic device 1502 acquires the first biometric signal.

The second electronic device 1502 acquires the first biometric signal using the second sensor module 323.

In step 1540, the second electronic device 1502 transmits information about the first biometric signal/the first signal pattern to the first electronic device 1501.

The second electronic device 1502 detects, from the first biometric signal, a part of the first signal pattern including at least one of at least one signal of the first type or at least one signal of the second type, and transmits information about the first signal pattern to the first electronic device 1501.

The second electronic device 1502 transmits the first biometric signal to the first electronic device 1501, and the first electronic device 1501 detects, from the first biometric signal, a part of the first signal pattern including at least one of at least one signal of the first type or at least one signal of the second type.

In step 1550, the first electronic device 1501 executes a first function corresponding to the first signal pattern.

The first electronic device 1501 determines response information for the first biometric signal based on the first signal pattern.

The first electronic device 1501 executes the first function, and acquires a result of executing the first function or a response to the execution of the first function as the response information.

In step 1560, the first electronic device 1501 outputs the response information to the second electronic device 1502.

In step 1570, the second electronic device 1502 outputs the response information through the second output device 326. For example, the response signal may include at least one of a haptic signal, an auditory signal, or a visual signal.

Referring to FIG. 16A, with a display 1606 being a first component of the second sensor module 323, in an inactive state a second electronic device 1601 (for example, the second electronic device 1502 of FIG. 15) acquires a second biometric signal representing a touch/tap of a user 1610 on the display 1606.

Referring to FIG. 16B, the second electronic device 1601 activates the display 1606 in response to the acquisition of the second biometric signal, and displays a graphic element 1620 (for example, a message or a window) on the display 1606 in order to indicate to a user that the second electronic device 1601 is in a standby state. The second electronic device 1601 activates a second component (for example, the accelerometer sensor 240E or a vibration sensor) of the second sensor module 323 needed to acquire a first biometric signal in response to the acquisition of the second biometric signal.

Referring to FIG. 16C, the second electronic device 1601 outputs response information 1630 (for example, information about reception of a response message) received from the first electronic device 1501 through the display 1606.

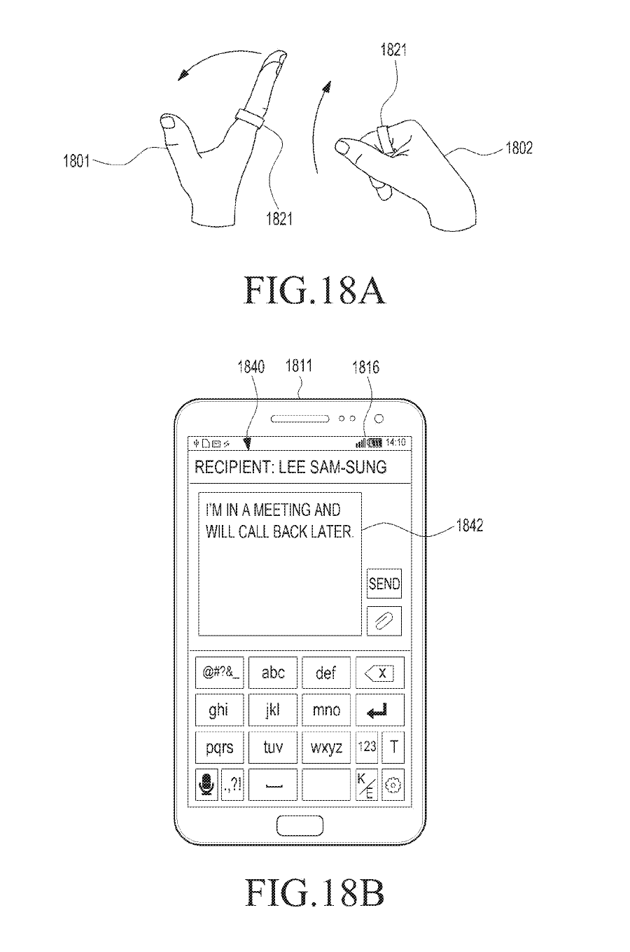

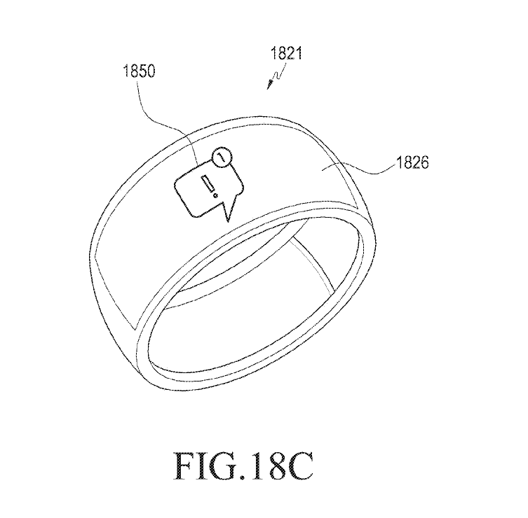

FIG. 17 is a signal flow diagram of a method for executing a function based on a biometric signal, according to an embodiment of the present disclosure. FIGS. 18A, 18B, and 18C illustrate a method for executing a function based on a biometric signal, according to an embodiment of the present disclosure.

Referring to FIG. 17, a method for executing a function based on a biometric signal performed by a first electronic device 1701, a second electronic device 1702, and a third electronic device 1703 is provided.

In step 1710, the second electronic device 1702 acquires a first biometric signal.

The second electronic device 1702 acquires the first biometric signal using the second sensor module 323.

In step 1720, the second electronic device 1702 transmits information about the first biometric signal/a first signal pattern to the first electronic device 1701.

The second electronic device 1702 detects, from the first biometric signal, a part of the first signal pattern including at least one of at least one signal of the first type or at least one signal of the second type, and transmits information about the first signal pattern (for example, the first signal pattern and an ID of the first signal pattern) to the first electronic device 1701.

The second electronic device 1702 transmits the first biometric signal to the first electronic device 1701, and the first electronic device 1701 detects, from the first biometric signal, a part of the first signal pattern including at least one of at least one signal of the first type or at least one signal of the second type.

In step 1730, the first electronic device 1701 generates a character sequence corresponding to the first signal pattern and a message including the character sequence, as a first function corresponding to the first signal pattern.

The first electronic device 1701 identifies or detects a character sequence corresponding to the first signal pattern. For example, the first electronic device 1701 detects a character sequence corresponding to the first signal pattern in a database of the first memory 318 of the first electronic device 1701. For example, the character sequence may include at least one of “I'm in a meeting and will call back later.”, “I'm talking on the phone and will call back soon.”, or “Please, help me urgently.”

The first electronic device 1701 identifies or detects a character sequence of a first language corresponding to the first signal pattern, and converts the character sequence of the first language to a character sequence of a second language. For example, the first electronic device 1701 detects the character sequence of the first language and the character sequence of the second language in the database of the first memory 318. For example, the character sequence of the first language may include “ [symbol] . [symbol] [symbol] .” and the character sequence of the second language may include “Please, help me urgently”.

Step 1730 may be performed by the second electronic device 1702, and in this case, the second electronic device 1702 transmits a transmission request including the generated message (and a recipient address of the message) to the first electronic device 1701.

In step 1740, the first electronic device 1701 transmits the message to the third electronic device 1703 through a network (for example, the network 162).

In step 1750, the first electronic device 1701 receives a response message to the message from the third electronic device 1703 through the network.

In step 1760, the first electronic device 1701 transmits response information included in or corresponding to the response message to the second electronic device 1702.

In step 1770, the second electronic device 1702 outputs the response information through the second output device 326. For example, the response signal includes at least one of a haptic signal, an auditory signal, or a visual signal.

Step 1770 may be performed by the first electronic device 1701 or by both of the first electronic device 1701 and the second electronic device 1702.

Referring to FIG. 18A, a second electronic device 1821 (for example, the second electronic device 1702 of FIG. 17) detects a first biometric signal/a first signal pattern (for example, - * - *) from an EMG signal detected along with a motion of spreading a hand 1801 and cupping a hand 1802.

Referring to FIG. 18B, a first electronic device 1811 (for example, the first electronic device 1701 of FIG. 17) generates a character sequence 1842 (for example, “I'm in a meeting and will call back later.”) corresponding to the first biometric signal/the first signal pattern. The first electronic device 1811 may pre-store a contact number of the message corresponding to the first biometric signal/the first signal pattern or the character sequence. The message may be transmitted automatically or by user confirmation.

The first electronic device 1811 displays a graphic element 1840 (for example, a message writing window) corresponding to or including the message. The first electronic device 1811 transmits the message to the pre-stored contact number according to user confirmation (for example, selection of a send button).

Referring to FIG. 18C, the second electronic device 1821 outputs response information 1850 received from the first electronic device 1811 to a display 1826 forming a part of the second output device 326.

As is apparent from the foregoing description of an embodiment, since an electronic device executes a function based on a biometric signal generated from a user, the user can easily control the electronic device in many different situations.

The term ‘module’ as used herein may include its ordinary meaning including, for example, a unit of one, or a combination of hardware, software, and firmware. The term ‘module’ may be used interchangeably with terms such as unit, logic, logical block, component or circuit. A ‘module’ may be the smallest unit of an integrated part or a portion thereof. A ‘module’ may be the smallest unit for performing one or more functions, or a portion thereof. A ‘module’ may be implemented mechanically, or electronically. For example, a ‘module’ may include at least one of a known, or to-be-developed, application-specific integrated circuit (ASIC) chip, field-programmable gate array (FPGA) or programmable logic device that perform certain operations.

According to various embodiments of the present disclosure, at least a part of apparatuses (for example, modules or their functions) or methods (for example, operations) may be implemented as commands stored in a computer-readable storage medium, in the form of a programming module. When the commands are executed by a processor (for example, the processor 120), the processor executes functions corresponding to the commands. The computer-readable storage medium may be, for example, the memory 130.

The computer-readable storage medium includes hard disk, floppy disk, magnetic media (for example, magnetic tape), optical media (for example, compact disc read-only memory (CD-ROM)), digital versatile disc (DVD), magneto-optical media (for example, floptical disk), hardware devices (for example, read-only memory (ROM), random access memory (RAM) or flash memory)), etc. Program instructions may include machine language code that is produced by a compiler or high-level language code that may be executed by a computer using an interpreter. The functionalities of hardware discussed above may be implemented as one or more software modules, and vice versa in order to perform an operation of the present disclosure.

A module or a programming module may include one or more of the above-described components, may omit a portion thereof, or may include additional components. Operations that are performed by a module, a programming module or other components according to the present disclosure may be processed in a serial, parallel, repetitive or heuristic manner. Also, some operations may be performed in a different order or omitted, or additional operations may be added.

According to an embodiment of the present disclosure, in a storage medium storing commands, the commands are configured to control a processor to perform the methods of the present disclosure.

The embodiments disclosed in the present specification are provided for description and understanding of the present disclosure, and are not intended to limit the scope of the present disclosure. Accordingly, the scope of the present disclosure should be interpreted as embracing all modifications and embodiments within the scope of the present disclosure therein. Therefore, the scope of the present disclosure is not defined by the detailed description or the embodiments described herein, but by the following claims and their equivalents.

What is claimed is:

1. An electronic device comprising:
a memory; and
a processor that acquires a first biometric signal, detects, from the first biometric signal, a part of a first signal pattern including at least one of at least one signal of a first type and at least one signal of a second type, and executes a first function corresponding to the first signal pattern.

2. The electronic device of claim 1, wherein the at least one signal of the first type is a short signal having a duration less than a first threshold, and the at least one signal of the second type is a long signal having a duration greater than or equal to the first threshold or a second threshold.

3. The electronic device of claim 1, wherein the processor:
compares a part of the first biometric signal with the first signal pattern pre-stored in the memory, and
determines the part of the first biometric signal to be the part of the first signal pattern, when the part of the first biometric signal matches the pre-stored first signal pattern.

4. The electronic device of claim 1, wherein the processor:
detects feature signals satisfying a first condition from the first biometric signal,
calculates a time interval between adjacent feature signals,
determines a combination of the adjacent feature signals to be a signal of the first type, when the time interval satisfies a second condition, and
determines the combination of the adjacent feature signals to be a signal of the second type, when the time interval satisfies a third condition.

5. The electronic device of claim 1, wherein the processor:
detects, from the first biometric signal, a first peak signal and a second peak signal having a magnitude greater than or equal to a threshold,
calculates a time interval between the first peak signal and the second peak signal,
determines a combination of the first peak signal and the second peak signal to be a signal of the first type, when the time interval satisfies a first condition, and
determines the combination of the first peak signal and the second peak signal to be a signal of the second type, when the time interval satisfies a second condition.

6. The electronic device of claim 1, wherein the processor:
identifies a character sequence corresponding to the first signal pattern, and
transmits a message including the character sequence to an external electronic device.

7. The electronic device of claim 6, wherein the processor:
receives a response message to the message, and
executes a second function based on response information included in the response message.

8. The electronic device of claim 1, wherein the processor:
acquires a second biometric signal, and
upon detection of a part of a third signal pattern pre-stored in the memory, from the second biometric signal, waits for the first biometric signal during a threshold time.

9. A method for executing a function based on a biometric signal in an electronic device, the method comprising:
acquiring a first biometric signal;
detecting, from the first biometric signal, a part of a first signal pattern including at least one of at least one signal of a first type and at least one signal of a second type; and
executing a first function corresponding to the first signal pattern.

10. The method of claim 9, wherein the at least one signal of the first type is a short signal having a duration less than a first threshold, and the at least one signal of the second type is a long signal having a duration greater than or equal to the first threshold or a second threshold.

11. The method of claim 9, wherein detecting the part of the first signal pattern comprises:
comparing a part of the first biometric signal with the pre-stored first signal pattern; and
determining the part of the first biometric signal to be the part of the first signal pattern, when the part of the first biometric signal matches the pre-stored first signal pattern.

12. The method of claim 9, wherein acquiring the first biometric signal comprises receiving the first biometric signal from an external electronic device.

13. The method of claim 9, wherein detecting the part of the first signal pattern comprises:
detecting, from the first biometric signal, a first peak signal and a second peak signal having a magnitude greater than or equal to a threshold;
calculating a time interval between the first peak signal and the second peak signal;
determining a combination of the first peak signal and the second peak signal to be a signal of the first type, when the time interval satisfies a first condition; and
determining the combination of the first peak signal and the second peak signal to be a signal of the second type, when the time interval satisfies a second condition.

14. The method of claim 9, wherein executing the first function comprises:
identifying a character sequence corresponding to the first signal pattern; and
transmitting a message including the character sequence to an external electronic device.

15. A non-transitory storage medium having stored thereon commands for executing a method comprising the steps of:
acquiring a first biometric signal;
detecting, from the first biometric signal, a part of a first signal pattern including at least one of at least one signal of a first type and at least one signal of a second type; and
executing a first function corresponding to the first signal pattern.

16. The non-transitory storage medium of claim 15, wherein the at least one signal of the first type is a short signal having a duration less than a first threshold, and the at least one signal of the second type is a long signal having a duration greater than or equal to the first threshold or a second threshold.

17. The non-transitory storage medium of claim 15, wherein detecting the part of the first signal pattern comprises:
comparing a part of the first biometric signal with the pre-stored first signal pattern; and
determining the part of the first biometric signal to be the part of the first signal pattern, when the part of the first biometric signal matches the pre-stored first signal pattern.

18. The non-transitory storage medium of claim 15, wherein acquiring the first biometric signal comprises receiving the first biometric signal from an external electronic device.

19. The non-transitory storage medium of claim 15, wherein detecting the part of the first signal pattern comprises:
detecting, from the first biometric signal, a first peak signal and a second peak signal having a magnitude greater than or equal to a threshold;
calculating a time interval between the first peak signal and the second peak signal;
determining a combination of the first peak signal and the second peak signal to be a signal of the first type, when the time interval satisfies a first condition; and
determining the combination of the first peak signal and the second peak signal to be a signal of the second type, when the time interval satisfies a second condition.

20. The non-transitory storage medium of claim 15, wherein executing the first function comprises:
identifying a character sequence corresponding to the first signal pattern; and
transmitting a message including the character sequence to an external electronic device.
